(19) United States
(12) Patent Application Publication
(10) Pub. No.: US 2004/0218127 A1
(43) Pub. Date: Nov. 4, 2004

(54) Display device, electronic apparatus, and method of manufacturing display device

(75) Inventor: Hirotsuna Miura, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/807,283

(22) Filed: Mar. 24, 2004

(30) Foreign Application Priority Data
Apr. 1, 2003 (JP) 2003-098436

(51) Int. Cl. G02F 1/1333

(52) U.S. Cl. 349/122

(57) ABSTRACT

To provide a display device, an electronic apparatus, and a method of manufacturing the display device, which are capable of preventing growth in size of a production line and the resultant increase in cost without deteriorating display quality, by using an elongate or contractile substrate, there is provided a display device in which an element layer having electrodes and a photo-functional layer is formed on a substrate, the substrate is made of an irreversible elongate material, and the element layer is made of an elastic material and provides an adhesive property to the substrate.

### BACKGROUND OF THE INVENTION

1. Field of Invention

The present invention relates to a display device in which an element layer having electrodes and a photo-functional layer is formed on a substrate, an electronic apparatus, and a method of manufacturing a display device.

2. Description of Related Art

In the related art, color display devices in which a light-emitting layer and a hole injection layer of each pixel are formed by a method of patterning a light-emitting material by using an inkjet method of ejecting a functional liquid including the light-emitting material, etc., specifically, organic EL (Electroluminescent) display devices employing organic light-emitting material as the light-emitting material, have been known. See Japanese Unexamined Patent Application Publication No. 10-12377.

In such organic EL display devices, an element layer (switching elements, electrodes, hole injection/transport layer, light-emitting layers, etc.) is formed on a substrate having a desired size, that is, a size in which the organic EL display devices are used as final products. Therefore, since increase in size of display panels is required, increase in size of manufacture apparatus to manufacture the organic EL display devices is inevitable. Thus increase in cost required for production lines is caused. Since the inkjet method is employed, the increase in size of substrates causes the time required to eject a functional liquid on the whole substrate to be increased, so that drying of ejecting nozzles or irregular drying of the functional liquid arriving at the substrate is caused. Therefore, it is difficult to manufacture the organic EL display devices.

In order to remove non-uniformity in emitting light, enhancement of product quality, such as uniformity in thickness of films made of the functional liquid, etc. has been required for organic EL display devices. For this reason, in a manufacturing apparatus, it is necessary to more accurately control the ejecting positions or the ejecting amount of the functional liquid. But it is also important together with the increase in size of the substrates.

The present invention is contrived to address the above problems. The present invention provides a display device, an electronic apparatus, and a method of manufacturing a display device, which are capable of preventing increase in size of production lines and the resultant increase in cost without deteriorating display quality, by using an elongate or contractile substrate.

### SUMMARY OF THE INVENTION

An aspect of the present invention provides a display device in which an element layer having electrodes and a photo-functional layer is formed on a substrate, the substrate made of an irreversible elongate material, and the element layer made of an elastic material and has an adhesive property to the substrate.

Another aspect of the present invention provides a method of manufacturing a display device in which an element layer having electrodes and a photo-functional layer is formed on a substrate, the substrate made of an irreversible elongate material, and the element layer made of an elastic material and having an adhesive property to the substrate. The method includes forming the element layer on the substrate and extending the substrate so as to make the display device be a desired size, after forming the element layer.

According to this construction, since the substrate is made of an irreversible elongate material, and the element layer formed on the substrate is made of an elastic material and has an adhesive property to the substrate, it is possible to manufacture a display device having a size larger than the original substrate by extending the substrate after forming the element layer. Therefore, in a case of manufacturing a large display device, it is possible to reduce or prevent the resultant increase in cost without enlarging a production line. Further, since the element layer is formed on the substrate having a size smaller than a desired size, it is possible to rapidly perform the application to one sheet of substrate, for example, using an inkjet method, so that it is possible to reduce or prevent the nozzles from being dried.

In a method of manufacturing a display device, the extension step may be performed using an X-axis direction extension mechanism to extend the substrate in an X-axis direction and a Y-axis direction extension mechanism to extend the substrate in a Y-axis direction. The substrate may be extended simultaneously in the two-dimensional directions by using an extension mechanism in which the X-axis direction extension mechanism and the Y-axis mechanism are coupled to each other.

According to this construction, since the substrate is extended in the two-dimensional direction, it is possible to obtain a display device enlarged two-dimensionally from the original substrate. Furthermore, since the extension mechanism to extend the substrate includes the X-axis direction extension mechanism and the Y-axis direction extension mechanism and they are connected to each other, it is possible to smoothly and simultaneously extend the substrate two-dimensionally.

In a method of manufacturing a display device, the display device may be a liquid crystal display device. The method may further include a liquid crystal injecting step of injecting a liquid crystal into the element layer after the element layer forming step, and in the extension step, the substrate may be extended after the liquid crystal injecting step.

According to this construction, in a case of a liquid crystal display device, since the substrate is extended after injecting the liquid crystal, it is possible to align the liquid crystal in the extension direction. Therefore, it is possible to omit the liquid crystal aligning process (a rubbing process, etc.) of aligning the liquid crystal.

The method of manufacturing a display device according to an aspect of the invention may further include forming step of forming a sealing layer to seal the substrate before the extension step, the sealing layer being made of thermosetting material which is cured in response to thermal energy or a light curable material which is cured in response to optical energy; and curing the sealing layer after the extension step.

According to this construction, by forming the sealing layer, it is possible to enhance the gas barrier property. Since the sealing layer is cured after extending the substrate, the extension is not hindered by the sealing layer.

According to another aspect of the present invention, there is also provided a display device in which an element layer having electrodes and a photo-functional layer is formed on a substrate, the substrate made of a thermal-shrinking material exhibiting shrinkage in response to thermal energy or a photo-shrinking material exhibiting shrinkage in response to optical energy. The element layer may be made of an elastic material and has an adhesive property to the substrate.

According to another aspect of the present invention, there is also provided a method of manufacturing a display device in which an element layer having electrodes and a photo-functional layer is formed on a substrate. The substrate is made of a thermal-shrinking material exhibiting shrinkage in response to thermal energy. The element layer is made of an elastic material and has an adhesive property to the substrate. The method includes forming the element layer on the substrate and shrinking the substrate in response to thermal energy after the element layer forming step.

According to another aspect of the present invention, there is also provided a method of manufacturing a display device in which an element layer having electrodes and a photo-functional layer is formed on a substrate. The substrate is made of optical-shrinking material exhibiting shrinkage in response to optical energy. The element layer is made of an elastic material and has an adhesive property to the substrate. The method includes forming the element layer on the substrate and shrinking the substrate by the optical energy after the element layer forming step.

According to this construction, since the substrate is made of a thermal-shrinking material exhibiting shrinkage in response to thermal energy or a photo-shrinking material exhibiting shrinkage in response to optical energy, and the element layer formed on the substrate is made of an elastic material and has an adhesive property to the substrate, it is possible to manufacture a display device having a size smaller than the original substrate by shrinking the substrate after forming the element layer. Therefore, even if the accuracy of the manufacturing apparatus is not largely enhanced in forming the element layer, it is possible to easily manufacture a display device having excellent qualities. For example, when the element layer is formed using the inkjet method, it is necessary to accurately eject a predetermined amount (predetermined times) of functional liquid in the minute pixel areas. However, since the functional liquid can be ejected in a state where the pixel areas are enlarged, it is possible to reduce errors in the ejection accuracy as much.

According to another aspect of the present invention, there is provided a display device in which an element layer having electrodes and a photo-functional layer is formed on a substrate, wherein both the substrate and the element layer made of an elastic material, and the element layer has an adhesive property to the substrate.

According to another aspect of the present invention, there is also provided a method of manufacturing a display device in which an element layer having electrodes and a photo-functional layer is formed on a substrate. Both the substrate and the element layer are made of an elastic material. The element layer has an adhesive property to the substrate. The method includes a pre-extension step of extending the substrate before forming the element layer; an element layer forming step of forming the element layer on the substrate after the pre-extension step; and a shrinking step of shrinking the substrate so as to make the display device be a desired size, after the element layer forming step.

According to this construction, since both the substrate and the element layer are made of an elastic material, and the element layer formed on the substrate has an adhesive property to the substrate, it is possible to manufacture a display device having a size larger or smaller than the original substrate, by extending or shrinking the substrate after forming the element layer. Therefore, it is possible to reduce or prevent the growth in size of a production line and the resultant increase in cost without deteriorating quality of a display device.

In the display device according to an aspect of the present invention, the substrate may be made of an autogenous shrinkable elastic material.

In the method of manufacturing a display device according to an aspect of the present invention, the substrate may be made of an autogenous shrinkable elastic material. In the pre-extension step, the substrate is fixed to an extended state by using an extension mechanism to extend the substrate in an X-axis direction and/or a Y-axis direction. Furthermore, in the shrinking step, the extension mechanism may be released.

According to this construction, since the substrate is made of an autogenous shrinkable elastic material, it is possible to restore the substrate to an original size, by fixing the element layer to the state where the substrate is previously extended by using the extension mechanism to extend the substrate in the X-axis direction and/or the Y-axis direction, forming the element layer, and then releasing the extension mechanism. That is, it is possible to manufacture a display device not requiring growth in size of a production line without using processes causing chemical change in the substrate material, etc.

In the display device according to an aspect of the present invention, the substrate may be made of an elastic material exhibiting irreversibility in response to thermal energy or optical energy.

In the method of manufacturing a display device according to an aspect of the present invention, the substrate may be made of an elastic material exhibiting irreversibility in response to thermal energy, and in the shrinking step, the thermal energy may be applied to the substrate at the same time as shrinking the substrate.

The method of manufacturing a display device according to an aspect of the present invention may include curing the substrate in response to thermal energy after the shrinking step.

The method of manufacturing a display device according to an aspect of the present invention may include curing the substrate in response to optical energy after the shrinking step.

According to this construction, since the substrate is made of an elastic material exhibiting irreversibility (being cured) in response to thermal energy or optical energy, it is possible to finally obtain a stable display device by applying the energy.

In the display device according to an aspect of the present invention, wires connected to the electrodes may be formed out of material obtained by dispersing metal particulates in a conductive polymer.

According to this construction, since the wires connected to the electrodes are formed out of material obtained by dispersing metal particulates in a conductive polymer, it is possible to reduce or prevent short-circuits due to the extension with securing conductivity.

According to an aspect of the present invention, there is also provided an electronic apparatus including the display device according to an aspect of the present invention, and a driving control device to drive and control the display device.

According to this construction, it is possible to provide an electronic apparatus not requiring growth in size of a production line without deteriorating quality of a display device.

The method of manufacturing a display device according to an aspect of the present invention may include forming a sealing layer to seal the substrate before the shrinking step, the sealing layer being made of thermosetting material which is cured in response to thermal energy, or light curable material which is cured in response to optical energy; and of curing the sealing layer after the shrinking step.

According to this construction, by forming the sealing layer, it is possible to enhance the gas barrier property. Further, since the sealing layer is cured after shrinking the substrate, the shrinking is not hindered by the sealing layer.

In the method of manufacturing a display device according to an aspect of the present invention, the display device may be an active panel and have active elements made of an elastic material. The method may include forming step of forming the active elements on the substrate.

According to this construction, since the active elements are made of an elastic material, it is possible to extend or shrink the substrate even when forming an active panel. Therefore, in this case, it is possible to reduce or prevent increase in cost due to growth in size of a production line without deteriorating quality of a display device.

In the method of manufacturing a display device according to an aspect of the present invention, one or two or more of the electrodes, the photo-functional layer, the sealing layer, and the active elements may be formed using an inkjet method.

According to this construction, by forming the electrodes, etc. using the inkjet method, it is possible to make the substrate out of various materials. Furthermore, it is possible to inexpensively and easily manufacture a display device with high quality.

### BRIEF DESCRIPTION OF THE DRAWINGS

FIG. 1 is a schematic illustrating an important part of a display device according to an exemplary embodiment of the present invention;

FIGS. 2a and 2b illustrate a schematic and a cross-sectional schematic, respectively, of a display device according to an exemplary embodiment;

FIG. 3 is a schematic of a functional liquid droplet ejecting apparatus according to an exemplary embodiment as seen two-dimensionally;

FIG. 4 is a schematic of an extension apparatus according to an exemplary embodiment as seen two-dimensionally;

FIG. 5 is a schematic of a chuck mechanism according to an exemplary embodiment;

FIGS. 6a and 6b are schematics illustrating an example of an extended state of the display device according to an exemplary embodiment;

FIGS. 7a and 7b are schematics illustrating an example of an extended state of a display device different from that of FIG. 6;

FIG. 8 is a flowchart illustrating a method of manufacturing an organic EL display device according to an exemplary embodiment;

FIG. 9 is a cross-sectional schematic illustrating a bank portion forming step (inorganic bank) in the method of manufacturing an organic EL display device according to an exemplary embodiment;

FIG. 10 is a cross-sectional schematic illustrating forming a bank portion (organic bank) in the method of manufacturing an organic EL display device according to an exemplary embodiment;

FIG. 11 is a cross-sectional schematic illustrating a plasma processing step (hydrophilic process) in the method of manufacturing an organic EL display device according to an exemplary embodiment;

FIG. 12 is a cross-sectional schematic illustrating a plasma processing step (hydrophobic process) in the method of manufacturing an organic EL display device according to an exemplary embodiment;

FIG. 13 is a cross-sectional schematic illustrating a hole injection layer forming step (ejection of functional liquid droplets) in the method of manufacturing an organic EL display device according to an exemplary embodiment;

FIG. 14 is a cross-sectional schematic illustrating a hole injection layer forming step (dry) in the method of manufacturing an organic EL display device according to an exemplary embodiment;

FIG. 15 is a cross-sectional schematic illustrating a surface reforming step (ejection of functional liquid droplets) in the method of manufacturing an organic EL display device according to an exemplary embodiment;

FIG. 16 is a cross-sectional schematic illustrating a surface reforming step (dry) in the method of manufacturing an organic EL display device according to an exemplary embodiment;

FIG. 17 is a cross-sectional schematic illustrating a B light-emitting layer forming step (ejection of functional liquid droplets) in the method of manufacturing an organic EL display device according to an exemplary embodiment;

FIG. 18 is a cross-sectional schematic illustrating a B light-emitting layer forming step (dry) in the method of manufacturing an organic EL display device according to an exemplary embodiment;

FIG. 19 is a cross-sectional schematic illustrating an R, G, B light-emitting layer forming step in the method of manufacturing an organic EL display device according to an exemplary embodiment;

FIG. 20 is a cross-sectional schematic illustrating a counter electrode forming step in the method of manufacturing an organic EL display device according to an exemplary embodiment;

FIG. 21 is a cross-sectional schematic illustrating a sealing step in the method of manufacturing an organic EL display device according to an exemplary embodiment;

FIG. 22 is a flowchart illustrating a method of manufacturing a liquid crystal display device according to a second exemplary embodiment;

FIG. 23 is an schematic of the liquid crystal display device according to the second exemplary embodiment;

FIG. 24 is a cross-sectional schematic of the liquid crystal display device according to the second exemplary embodiment;

FIGS. 25a and 25b are schematics illustrating an example of a shrunk state of a display device according to a third exemplary embodiment; and

FIG. 26 is a schematic illustrating an example of an extension mechanism according to a fourth exemplary embodiment.

### DETAILED DESCRIPTION OF EXEMPLARY EMBODIMENTS

Now, a display device, an electronic apparatus, and a method of manufacturing the display device according to aspects of the present invention will be described with reference to the accompanying drawings. Since an inkjet head (a functional liquid droplet ejecting head) of an inkjet printer (a functional liquid droplet ejecting apparatus) can accurately eject fine ink droplets (functional droplets) in dot shapes, the inkjet head is expected to be applied to a field of manufacturing various components, for example, by using a special ink or a light-emitting or photosensitive resin as the functional liquid (ejected liquid). In this exemplary embodiment, in a method of manufacturing a so-called flat display, such as an organic EL display device or a liquid crystal display device, a case where an EL light-emitting layer and a hole injection layer of each pixel in the organic EL display device are formed or filter elements for R, G and B, etc. in the liquid crystal display device are formed by ejecting a functional liquid of filter material or light-emitting material, etc. from functional liquid droplet ejecting heads of a functional liquid droplet ejecting apparatus (inkjet method) is exemplified. Further, as the display device, a so-called active matrix type display device in which pixels are arranged in a matrix shape and have active elements is exemplified.

In the display device according to this exemplary embodiment, by making the constituent elements thereof out of elongate or contractile material, it is possible to form switching elements or an element layer (electrodes, a hole injection/transport layer, a light-emitting layer, and the like) on a substrate having a size smaller than a desired size, or form the elements or the element layer on a substrate having a size larger than the target size. According to this construction, it is possible to reduce or prevent growth in size of a production line and the resultant increase in cost. It is also possible to accomplish enhancement in product quality of the display device.

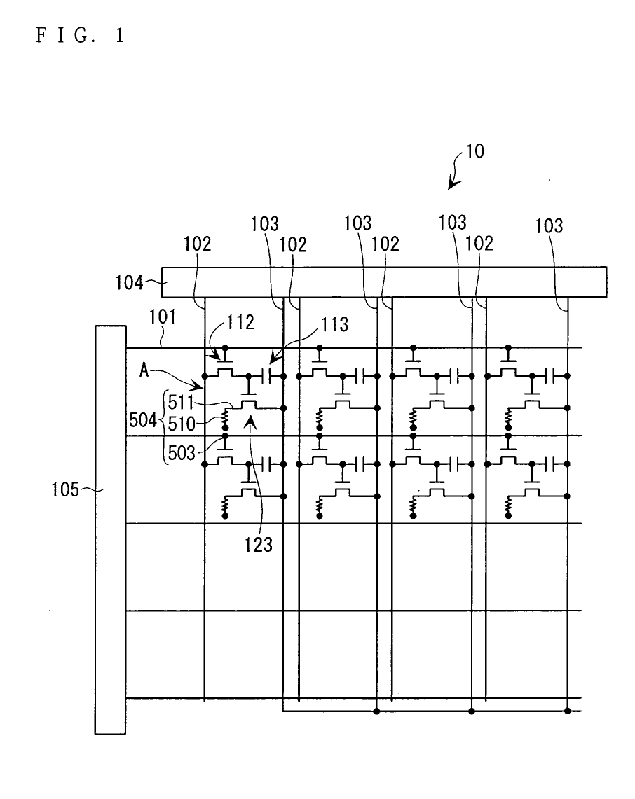

First, in a first exemplary embodiment, as a method of manufacturing an organic EL display device 10, a case where an element layer 20 is formed on a substrate having a size smaller than a desired size will be described. As shown in FIG. 1, the display device 10 according to this exemplary embodiment includes a data-side driving circuit 104 which edits data signals (image signals) input externally and has a shift register, a level shifter, video lines and analog switches, a plurality of signal lines 102 connected to the data-side driving circuit 104, a scanning-side driving circuit 105 having a shift register and a level shifter, a plurality of scanning lines 101 connected to the scanning-side driving circuit 105 and extending in a direction perpendicular to the signal lines 102, and a plurality of pixel areas A provided in the vicinities of intersections between the signal lines 102 and the scanning lines 101.

Each pixel area A includes a switching thin film transistor 112, a storage capacitor cap (condenser) 113 to hold a pixel signal supplied from the signal line 102 through the switching thin film transistor 112, a driving thin film transistor 123 of which the gate electrode is supplied with the pixel signal held by the storage capacitor cap 113, a pixel electrode 511 into which a driving current flows from a power source line 103 when it is connected to the power source line 103 through the driving thin film transistor 123, a negative electrode 503 which is a counter electrode opposed to the pixel electrode 511, and a photo-functional layer 510 interposed between the pixel electrode 511 and the negative electrode 503. The pixel electrode 511, the negative electrode 503 and the photo-functional layer 510 constitute a display element 504, and the switching thin film transistor 112, the storage capacitor cap (condenser) 113 and the driving thin film transistor 123 constitute an active element.

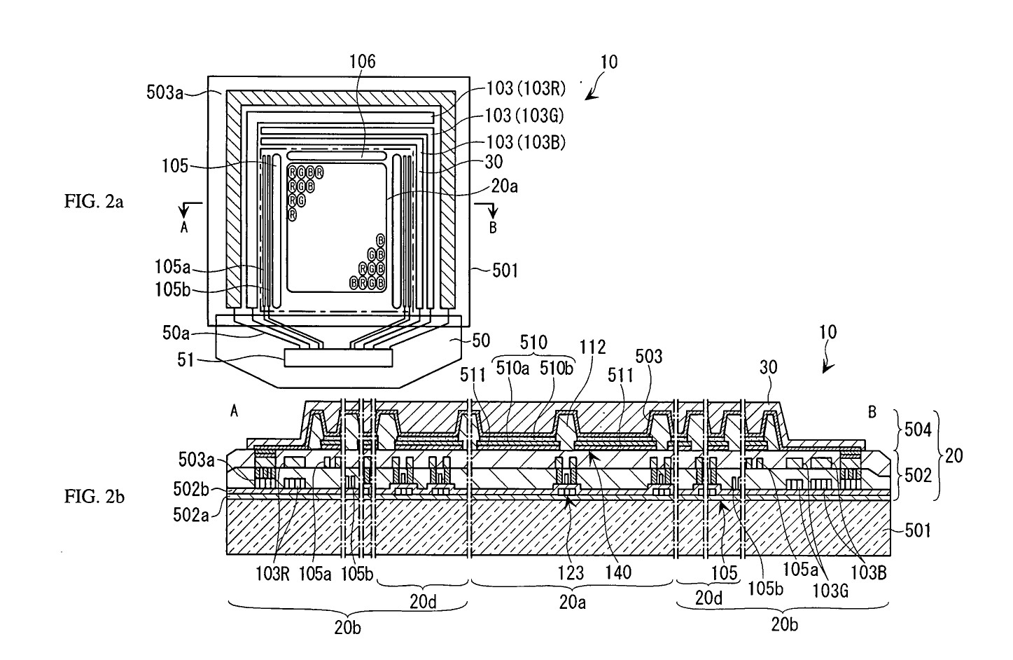

In the display device 10 having such a construction, when the scanning line 101 is driven and the switching thin film transistor 112 is turned on, a potential of the signal line 102 at that instant is held by the storage capacitor cap 113, and the driving thin film transistor 123 is turned on or off depending upon the potential held by the storage capacitor cap 113. Current flows into the pixel electrode 511 through a channel of the driving thin film transistor 123 from the power source line 103, and current flows into the negative electrode 503 through the photo-functional layer 510. That is, while the current flows in the photo-functional layer 510, a light-emitting layer 510b (see FIG. 2) emits light continuously.

Next, a construction of the display device 10 will be described with reference to FIG. 2. FIG. 2a is a schematic of the display device 10, and FIG. 2b is a cross-sectional schematic of the display device 10. As shown in the figures, the display device 10 is constructed by stacking a substrate 501 made of transparent resin having high gas barrier property, an element layer 20 having electrodes 503, 511 and photo-functional layers 510, and a sealing layer 30 to seal the substrate 501.

The substrate 501 is obtained by forming a transparent resin having elongate property and irreversibility (a PC resin, a PET resin, a PAR resin, a PAN resin, a PES resin, an a-PO (norbomene) resin, a transparent fluorine resin other than PCTEE, a PVA extruded product, etc.) in a film shape, and is divided into a display area 20a positioned at the center thereof and a non-display area 20b surrounding the display area.

In this case, the display elements 504 arranged in a matrix shape are formed in the display area 20a, and R (red), G (green) and B (blue) pixels are arranged pursuant to a predetermined rule. In the figures, a stripe arrangement in which the pixels of the same color are arranged in a line (in a stripe shape) is shown. However, the pixels may be arranged in a mosaic arrangement in which the pixels of the same color are arranged obliquely, and the shape of arrangement is not limited. An inspection circuit 106 to inspect quality and defects of the display device 10 during manufacture or in shipping is provided at an upside of the display area 20a in FIG. 2a.

A dummy display area 20d adjacent to the display area 20a is provided in the non-display area 20b. The aforementioned scanning-side driving circuit 105 is arranged in the circuit element layer 502 of the dummy display area 20d. In the circuit element layer 502 of the non-display area 20b, the aforementioned power source lines 103 (103R, 103G, 103B) are arranged, and driving-circuit control signal lines 105a and a driving-circuit power source line 105b connected to the scanning-side driving circuit 105 are provided.

As shown in FIG. 2b, the element layer 20 is largely divided into the circuit element layer 502 and the display element layer 504. In the circuit element layer 502, a base protective film 502a made of a silicon oxide film is formed on the substrate 501. A semiconductor film 502b made of polycrystalline silicon is formed thereon. Further, the circuit element layer 502 includes the scanning lines 101, the signal lines 102, the storage capacitors cap 113, the switching thin film transistors 112 and the driving thin film transistors 123. Furthermore, in the display element layer 504, light-emitting elements 140 having the pixel electrodes 511 and the photo-functional layers 510, and the negative electrode 503 are provided.

One end of the negative electrode 503 is connected to a negative electrode line 503a formed on the substrate 501. One end of the negative electrode line 503a is connected to a wire 50a on a flexible substrate 50 (see FIG. 2(a)). The wire 50a is connected to a driving IC (driving circuit) 51 similarly provided on the flexible substrate 50.

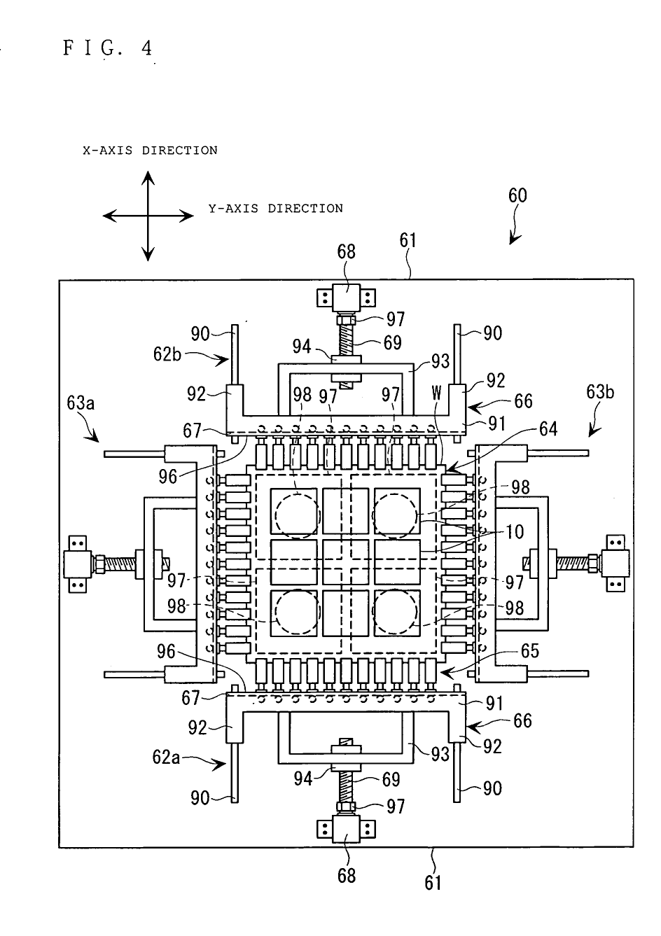

The sealing layer 30 is made of light curable material (ultraviolet curing resin, etc.) which is cured in response to optical energy, and reduces or prevents inflow of water or oxygen to reduce or prevent the negative electrode 503 or the light-emitting layers 510b formed out of photo-functional layers 510 from being oxidized. The sealing layer 30 is formed using an inkjet method, the substrate 501 is extended, and then the sealing layer is cured with the optical energy (an ultraviolet lamp 98; see FIG. 4).

The sealing layer 30 may be made of thermosetting material (a thermosetting resin, such as an epoxy resin) which is cured in response to thermal energy. In this case, the sealing layer 30 is cured with the thermal energy (heating). As needed, a thin film as a gas barrier may be formed at the lower side of the sealing layer 30 (at the upper side of the negative electrode 503). The thin film may be made of inorganic material such SiO₂, SiN, etc.

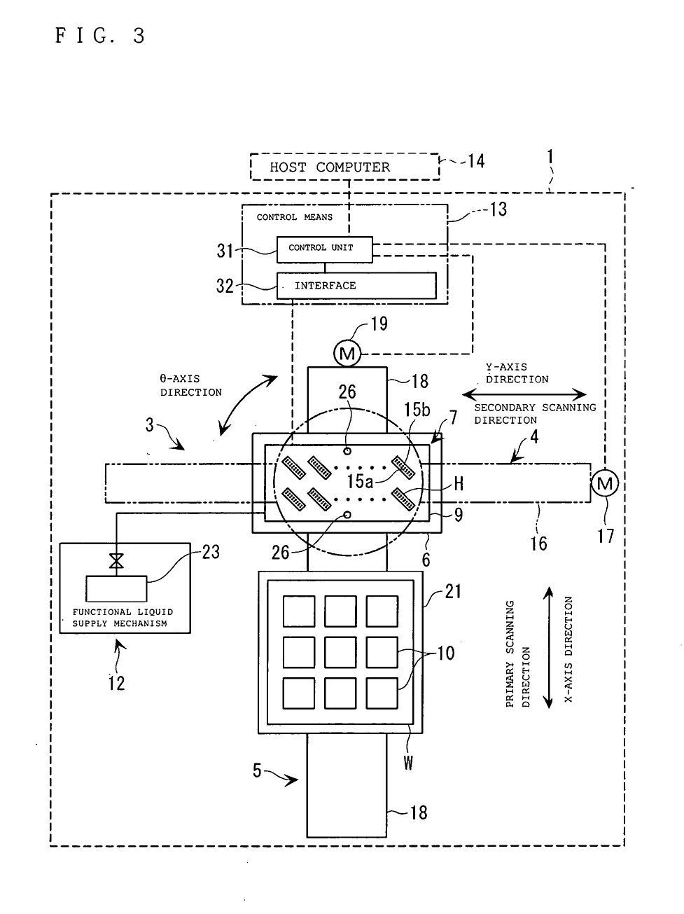

Next, a functional liquid droplet ejecting apparatus 1 to form the pixel electrodes 511, the photo-functional layers 510, etc. in addition to the sealing layer 30 by using the inkjet method will be described with reference to FIG. 3. The functional liquid droplet ejecting apparatus 1 according to this exemplary embodiment includes an X-axis table 5 and a Y-axis table 4 perpendicular to the X-axis table constituting a movement mechanism 3 provided on a base platform, a main carriage 6 provided movably on the Y-axis table 4, and a head unit 7 mounted on the main carriage 6. On the head unit 7, functional liquid droplet ejecting heads H in which two nozzle lines 15a, 15b are arranged are mounted with a sub carriage 9 therebetween. A mother board W which is a work is mounted on the X-axis table 5. A plurality of substrates 501 (chips) (nine substrates in the figure) are arranged on the mother board W, where one chip area corresponds to a display area 20a of one display device 10. The arrangement of the plurality of chips is not limited to this shape.

A functional liquid supply mechanism 12 to supply a functional liquid to the functional liquid droplet ejecting heads H is fitted to the functional liquid droplet ejecting apparatus 1, and a control device 13 to control the driving of the aforementioned movement mechanism 3 and the functional liquid droplet ejecting heads H is also fitted thereto. A host computer 14 to generate driving waveform data or ejection pattern data of the functional liquid droplet ejecting heads H is connected to the control device 13.

The control device 13 has a control unit 31 which generally controls the functional liquid droplet ejecting apparatus 1 and is connected to the host computer 14. The control device controls an X-axis motor 19 to drive the X-axis table 5, and controls the Y-axis motor 17 to drive the Y-axis table 4. Furthermore, the control device inputs clock signals, ejection signals, latch signals and driving signals to the functional liquid droplet ejecting heads H through an interface 32, and drives and controls the functional liquid droplet ejecting heads H.

Although not shown, in addition to a flushing unit to carry out a regular flushing of the functional liquid droplet ejecting heads H (wastefully ejecting the functional liquid from the overall ejecting nozzles to recover a function thereof) or a wiping unit to wipe nozzle surfaces of the functional liquid droplet ejecting heads H, a cleaning unit to suck and store a functional liquid of the functional liquid droplet ejecting heads H, etc. is fitted to the functional liquid droplet ejecting apparatus 1.

The Y-axis table 4 has a Y-axis slider 16 to be driven by a motor 17 constituting a Y-axis direction driving system. The main carriage 6 is mounted movably on the Y-axis slider. Similarly, the X-axis table 5 has an X-axis slider 18 to be driven by a motor 19 constituting a X-axis direction driving system, and a set table 21 including a suction table, etc. is mounted movable on the X-axis slider. The mother board W is positioned and set onto the set table 21.

In the functional liquid droplet ejecting apparatus 1 according to this exemplary embodiment, the functional liquid droplet ejecting heads 10 are driven (selectively ejects the functional liquid droplets) in synchronism with movement of the functional liquid droplet ejecting heads 10 by the X-axis table 5. A so-called primary scanning of the functional liquid droplet ejecting heads 10 is performed through reciprocation of the X-axis table 5 in the X-axis direction. A so-called secondary scanning is performed through reciprocation of the mother board W in the Y-axis direction by Y-axis table 4. The driving of the functional liquid droplet ejecting heads H in the scanning is performed on the basis of the driving waveform data and the ejection pattern data prepared by the aforementioned host computer 14.

The functional liquid supply mechanism 12 has a sub tank 23 to supply the functional liquid to the functional liquid droplet ejecting heads H (respective nozzle lines 15a, 15b), and also has a main tank connected to the sub tank 23 and a compressive supply unit to supply the functional liquid in the main tank to the sub tank 23, although not shown. The functional liquid in the main tank is compressively supplied to the sub tank. The functional liquid compressively shut in the sub tank 23 is supplied to the functional liquid droplet ejecting heads H through pumping operation of the functional liquid droplet ejecting heads H. Although not shown, the compressive supply unit is controlled by the aforementioned control device 12.

The head unit 7 includes a sub carriage 9 made of a thick plate of stainless steel material and the functional liquid droplet ejecting heads H accurately positioned and fixed onto the sub carriage 9. At central positions of the sub carriage 9 in the right-left direction, a pair of reference pins (marks) 26, 26 are provided as a positioning reference of the head unit 7. 180 nozzles are arranged in a line shape in the respective functional liquid droplet ejecting heads H, where two nozzle lines 15a, 15b are arranged in parallel. The functional liquid droplet ejecting heads H are arranged to be oblique by a predetermined angle about the primary scanning direction (the X-axis direction), and by adjusting the tilt angle in the θ axis direction shown in the figure, a nozzle pitch can be allowed to correspond to a pixel pitch.

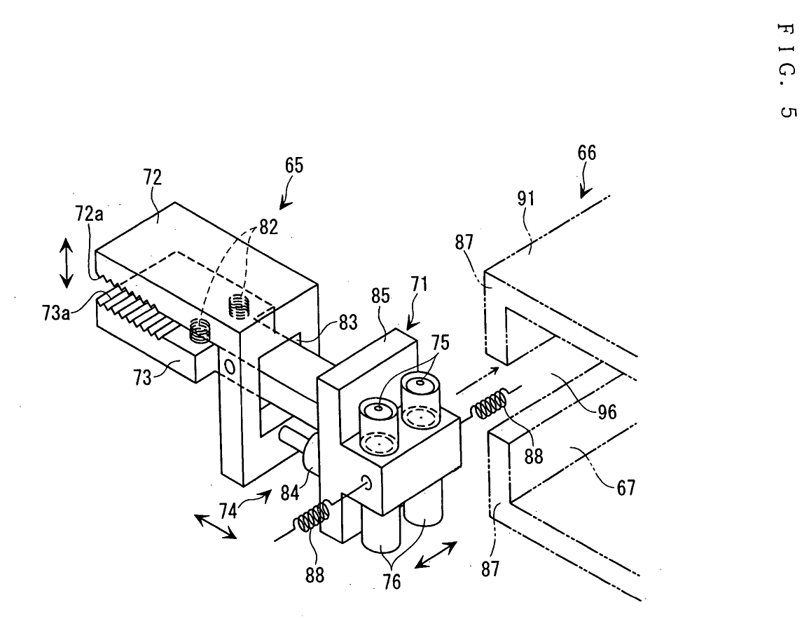

Next, an extension apparatus 60 to extend the mother board W (substrate 501) will be described with reference to FIGS. 4 and 5. As shown in the figures, the extension apparatus 60 includes a pair of X-axis direction extension mechanisms 62a, 62b and a pair of Y-axis direction extension mechanisms 63a, 63b, which are arranged on a bedplate 61 to face each other, respectively. A square-shaped set stage 64 in contact with the mother board W is formed at the center of the bedplate 61, where the X-axis direction extension mechanisms 62a, 62b face each other at one opposite sides of the set state 64, and the Y-axis direction extension mechanisms 63a, 63b face each other at the other sides. Since the X-axis direction extension mechanisms 62a, 62b and the Y-axis direction extension mechanisms 63a, 63b have the same construction, here, the X-axis direction extension mechanisms 62a, 62b will be mainly described. Description of the Y-axis direction extension mechanisms 63a, 63b will be omitted.

The respective X-axis direction extension mechanisms 62a, 62b include a plurality of chuck mechanisms 65 to grasp one side of the mother board W, a pair of guide rails 67 to slidably support the plurality of chuck mechanisms 65 in the Y-axis direction, a geared motor 68 to linearly move a chuck holder 66 holding the chuck mechanisms 65 in the X-axis direction, and a ball screw (lead screw) 69 to convert rotation of the geared motor 68 into linear movement and transferring the linear movement to the chuck holder 66. The plurality of chuck mechanisms 65 are arranged in parallel and at regular intervals to be close to each other.

As shown in FIG. 5, each chuck mechanism 65 has a base block 71 held by the chuck holder 66, a lower grasp piece 73 extending forwardly from the base block 71, an upper grasp piece 72 opposed to the lower grasp piece 73 and rotatably fitted to the lower grasp piece 73, and a solenoid 74 to rotate the upper grasp piece 72 with respect to the lower grasp piece 73. Upper and lower pairs of rollers 75, 76, that is, four rollers in total, to slidably come in contact with the chuck holder 66 are provided in the base block 71.

The upper grasp piece 72 and the lower grasp piece 73 vertically opposed have slide preventing portions 72a, 73a to grasp the mother board W at front half portions of the opposed surfaces thereof, respectively, and a pair of compression springs 82 are provided at rear half portions of the upper grasp piece 72 and the lower grasp piece 73. The upper grasp piece 72 is bent in an L shape. A penetrating opening 83 to allow the lower grasp piece 73 to pass is formed in the bent portion, where the lower grasp piece 73 is axially supported to be freely rotated. A plunger 84 of the solenoid 74 provided in the base block 71 is connected to a lower end portion of the bent portion.

When the solenoid 74 is excited, the upper grasp piece 72 is rotated downwardly against the compression springs 82 to strongly grasp the mother board W of which an edge is in contact with the slide preventing portion 73a of the lower grasp piece 73. In this state, when the solenoid 74 is degaussed, the upper grasp piece 72 is rotated upwardly with a spring force of the compression spring 82 to release the state grasping the mother board W.

The base block 71 is formed in a horizontal “T” shape at a flange portion 85 and a rib portion 86, respectively, and the respective pairs of rollers 75, 76 are provided rotatably on upper and lower surfaces of the rib portion 86, respectively. Each of the pair of rollers 75, 76 can be rotated about its vertical axis. Upper and lower guide pieces 87 of the chuck holder 66 to be described later are interposed between an inner surface of the flange portion 85 and the rollers, so that the rollers come slidably in contact with the chuck holder 66 and are held by the chuck holder.

A reference numeral 88 in the figure denotes tension springs. The plurality of chuck mechanisms 65 are connected to each other by the tension springs 88 at the respective base blocks 71. Two tension springs 88 extending from two chuck mechanisms 65 positioned at both outermost ends are connected to the pair of Y-axis direction extension mechanisms 63a, 63b, respectively. That is, when the pair of Y-axis direction extension mechanisms 63a, 63b are withdrawn and the mother board W is extended in the Y-axis direction, the respective chuck mechanisms 65 are thus drawn and moved outwardly. The respective chuck mechanisms 65 smoothly slide in the Y-axis direction in a state where the respective chuck mechanisms 65 are held by the chuck holder 66, through the drawing by the tension springs 88.

The chuck holder 66 has a holder body 91 to slidably hold the plurality of chuck mechanisms 65, a pair of slide portions 92 being bent and extending outwardly from both outer ends of the holder body 91, an arm portion 93 having a “U” shape which is positioned in the pair of slide portions 92 and extends outwardly from the holder body 91, and a female screw block 94 provided at the center of the arm portion 93. The lower surfaces of the pair of slide portions 92 are slidably fitted to a pair of guide rails 90 extending in the X-axis direction on the bedplate 61.

The holder body 91 has a section of a “C” shape, the rib portions of the base blocks are inserted into an opening portion of a slit thereof. The upper and lower guide pieces 87 constituting the opening portion 96 are sandwiched between the flange portions 85 and the upper and lower rollers 75, 76 of the chuck mechanisms 65 (see virtual lines in FIG. 5). As a result, the respective chuck mechanisms 65 can freely slide in the Y-axis direction by means of the tension in the X-axis direction.

The geared motor 68 is connected to the ball screw 69 through a coupling 97. The ball screw 69 is screw-coupled to the female screw block 94 of the chuck holder 66. When the ball screw 69 is rotated by the rotation of the geared motor 68, the chuck holder 66 is guided into the pair of guide rails 90 through the arm portion 93, and thus goes forwardly and backwardly. That is, by withdrawal of the chuck holder 66, the mother board W grasped with the plurality of chuck mechanisms 65 is drawn outwardly and extended.

Four convex sections 97 defined by a cross-shaped partition are formed on the set stage 64. The four convex sections 97 are in contact with almost the whole bottom surface of the mother board W set onto the set stage 64. An ultraviolet lamp 98 is received in each convex section 97. Though application of the ultraviolet ray from the ultraviolet lamps 98, the sealing layer 30 made of ultraviolet curable resin can be cured.

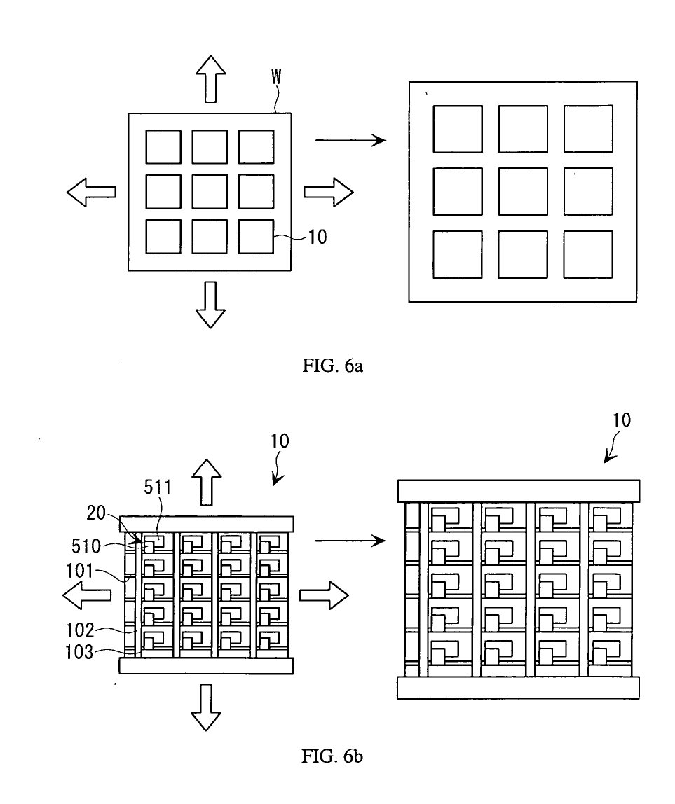

FIG. 6a shows a state of the mother board W which is extended by the extension apparatus. FIG. 6b shows a state of the display device 10 (a chip) which is extended thereby. As described above, the display device 10 is simultaneously extended in the X-axis direction and the Y-axis direction (the two-dimensional directions) by the X-axis direction extension mechanisms 62a, 62b and the Y-axis direction extension mechanisms 63a, 63b. In this case, as shown in FIG. 6b, the scanning lines 101, the signal lines 102, the power source lines 103, the photo-functional layers 510 and the pixel electrodes 511 formed on the substrate 501 are extended together with the substrate 501 whiling maintaining the same arrangement. As a result, it is possible to rapidly obtain the display device 10 enlarged two-dimensionally, that is, enlarged with the same scale in the longitudinal direction and the lateral direction, from the size of the original substrate 501.

Accordingly, in the extension apparatus 60 according to this exemplary embodiment, since the extension mechanism to extend the mother board W includes the X-axis direction extension mechanisms and the Y-axis direction extension mechanisms and these are connected to each other, it is possible to smoothly extend the mother board W. Thus it is possible to rapidly obtain the display device 10 enlarged two-dimensionally from the original mother board W. Furthermore, since the mother board W is extended before separating the individual display devices 10, it is not necessary to provide grasp areas to be grasped by the chuck mechanisms 65 in the individual display devices 10. Furthermore, since plural sheets of display devices 10 can be simultaneously extended or shrunk, it is possible to reduce labors of processing the individual devices.

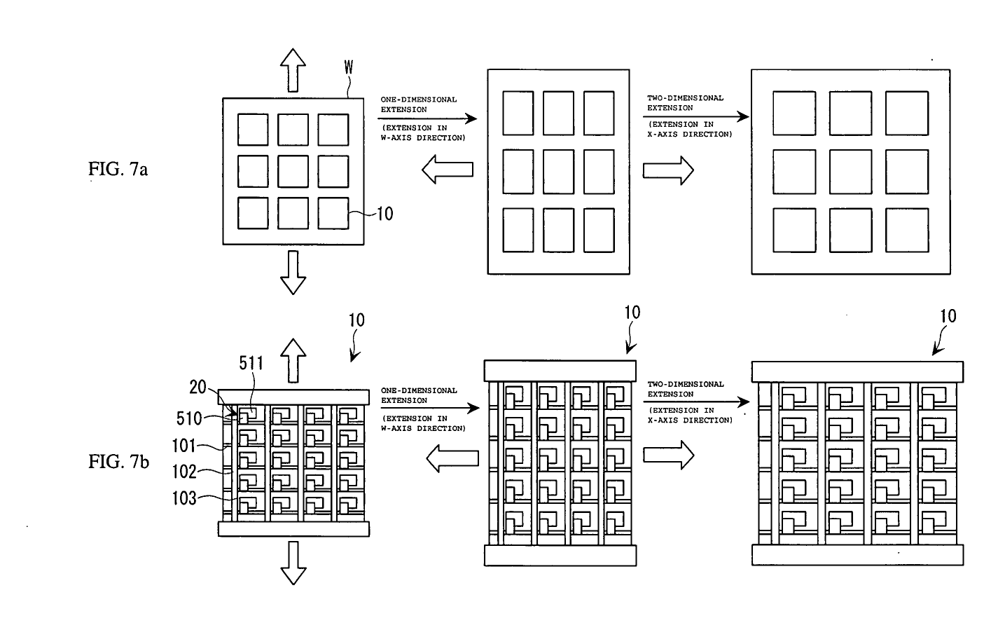

In place of simultaneously and smoothly extending the mother board W two-dimensionally, the mother board may be extended one-dimensionally (in the X-axis direction or the Y-axis direction) as shown in FIG. 7. In this case, it is preferable that the tension springs 88 extending from the two chuck mechanisms 65 positioned at both outermost ends in the X-axis direction may not be connected to the pair of Y-axis direction extension mechanisms 63a, 63b, and fixed to the chuck holder 66. Then, the extension process may be performed using only one pair of extension mechanisms of the pair of X-axis direction extension mechanisms 62a, 62b and the pair of Y-axis direction extension mechanisms 63a, 63b.

As shown in the figure, by extending the mother board one-dimensionally in the X-axis direction and then extending the mother board two-dimensionally in the Y-axis direction, it is possible to obtain the display device 10 enlarged two-dimensionally, similarly to the case shown in FIG. 6. In this way, by extending the mother board W one-dimensionally and then extending the mother board two-dimensionally (extending by two steps), it is possible to easily and surely extend the mother board W (substrate 501).

In the above example, the mother board W before the cut-out has been extended. But the individual substrates 501 (chips) after the cut-out may be extended. According to this construction, it is possible to allow the extension apparatus 60 to grow in size and to enhance the yield.

The aforementioned extension apparatus 60 may be fitted into the function liquid droplet ejecting apparatus 1 shown in FIG. 3. According to this construction, it is not necessary to separately provide the extension apparatus 60. It is also possible to reduce the labor of mounting the mother board W (substrate 501) onto the respective apparatus 1, 60 and removing the mother board therefrom.

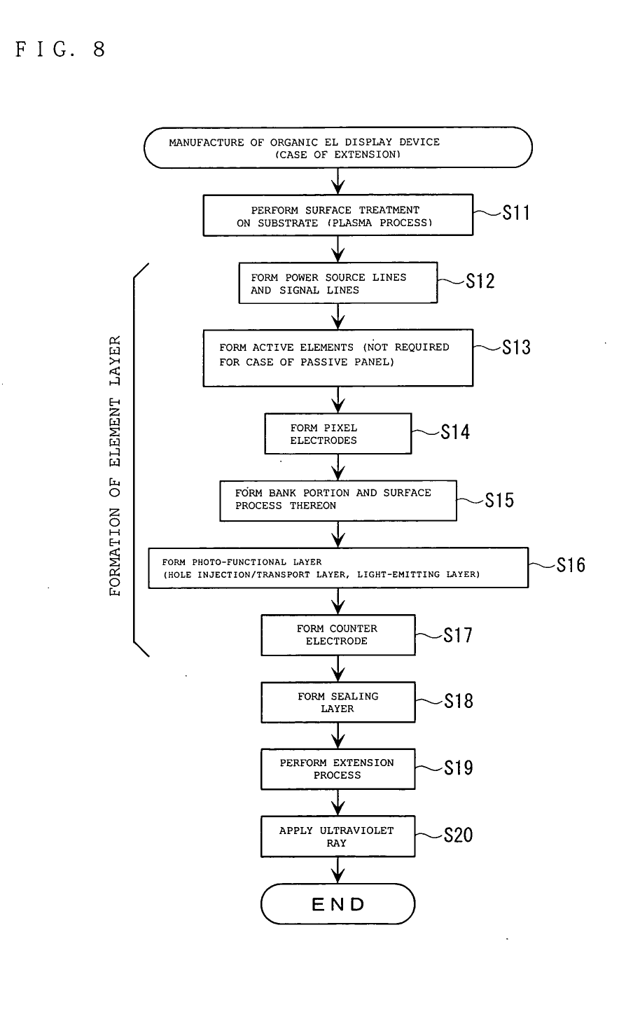

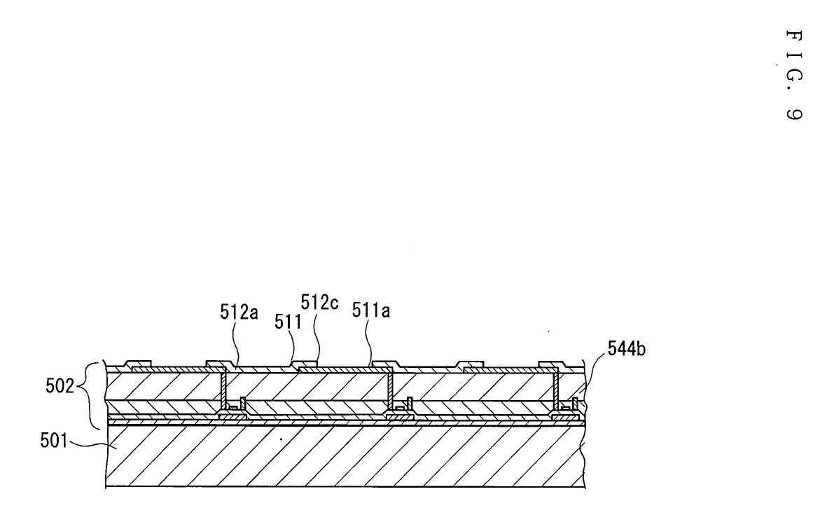

Next, a method of manufacturing the organic EL display device 10 will be described with reference to FIGS. 8 to 21. FIG. 8 is a flowchart illustrating the method of manufacturing the organic EL display device 10, and FIGS. 9 to 21 show the respective processes of manufacturing the organic EL display device 10 and structures thereof. As described above, in this exemplary embodiment, the organic EL display device 10 is manufactured by forming the element layer 20 on the substrate 501 having a size smaller than a desired size and then extending the substrate 501 after forming the element layer 20. In the manufacture processes, the surface treatment process (a plasma process) on the substrate 501 is first performed as shown in FIG. 8 (S11). The substrate 501 is made of transparent resin having elongate property and irreversibility.

The surface treatment process largely includes a preliminary heating process, a lyophilic process of processing the surface to have a lyophilic property, and a cooling process. First, in the preliminary heating process, the substrate 501 is heated up to a predetermined temperature. The heating process is performed, for example, by providing a heater in a stage on which the substrate 501 is mounted and heating the substrate 501 on the stage by the heater. Specifically the temperature for preliminarily heating the substrate 501 may be in the range of 70° C. to 80° C.

Next, in the lyophilic process, a plasma process (O₂ plasma process) using oxygen gas as a process gas in the atmosphere is performed. Through the O₂ plasma process, hydroxyl group is introduced into the surface of the substrate 501. Thus the lyophilic property is given to the surface. Next, in the cooling process, the substrate 501 heated in the plasma process is cooled to a room temperature or a management temperature of the inkjet process (functional liquid droplet ejecting process). By cooling the substrate 501 after the plasma process to the room temperature or the predetermined temperature (for example, the management temperature to perform the functional liquid droplet ejecting process), the processes to be described later can be performed at a constant temperature. In this way, by performing the surface treatment process (the plasma process), it is possible to enhance the adhesive property between the substrate 501 and the element layer 20 to be described later.

Next, the element layer 20 is formed (S12 to S17). The element layer 20 is wholly made of an elastic material which can be extended and shrunk with the extension and shrinking of the substrate 501. First, the aforementioned power source lines 103, signal lines 102, etc. are formed (S12). These lines are formed by applying a functional liquid in which metal particulates are dispersed in a conductive polymer by using the inkjet method. By using such functional liquid, it is possible to secure the conductivity and to reduce or prevent short-circuits due to the extension. Subsequently, the active elements (the switching thin film transistors 112, the storage capacitors cap (condensers) 113, the driving thin film transistors 123, etc.) are formed, but this process is not necessary in a case where the organic El display device 10 is a passive panel (S13). The active elements are formed through ejection (application) of a functional liquid by using the inkjet method, that is, the functional liquid droplet ejecting apparatus (see FIG. 3).

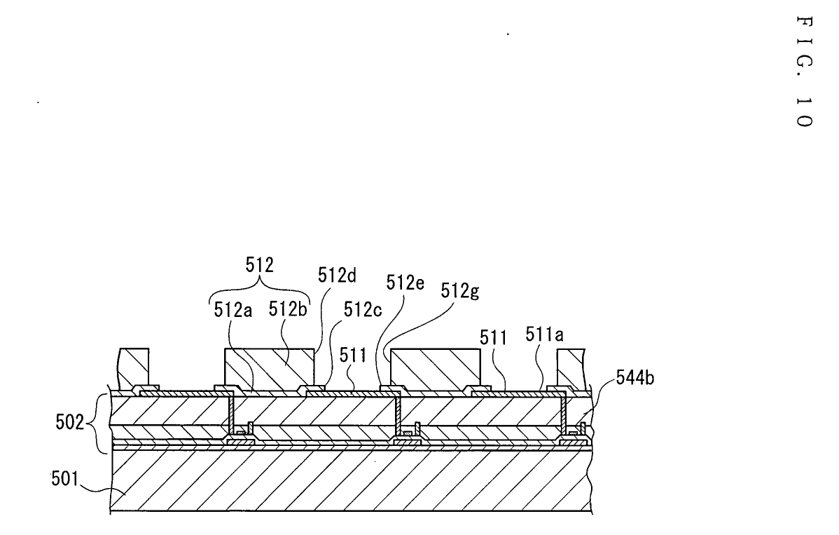

Subsequently, the pixel electrodes 511 are formed (S14). Here, the pixel electrodes 511 are formed by applying and drying a functional liquid in which ITO (Indium Tin Oxide) particulates are dispersed using the deposition method, etc. Subsequently, bank portions 512 (see FIGS. 9 and 10) are formed in the vicinity of the ends or the whole surface of the substrate 501 in accordance with the extension rate of the substrate 501 or the ejection accuracy of the functional liquid droplet ejecting apparatus 1 (S15: the formation of the bank portions is not necessary in a case where the extension rate is high or the ejection accuracy is high). In this case, the bank portions 512 are subjected to a lyophobic process. Further, the surface treatment process may be performed as needed.

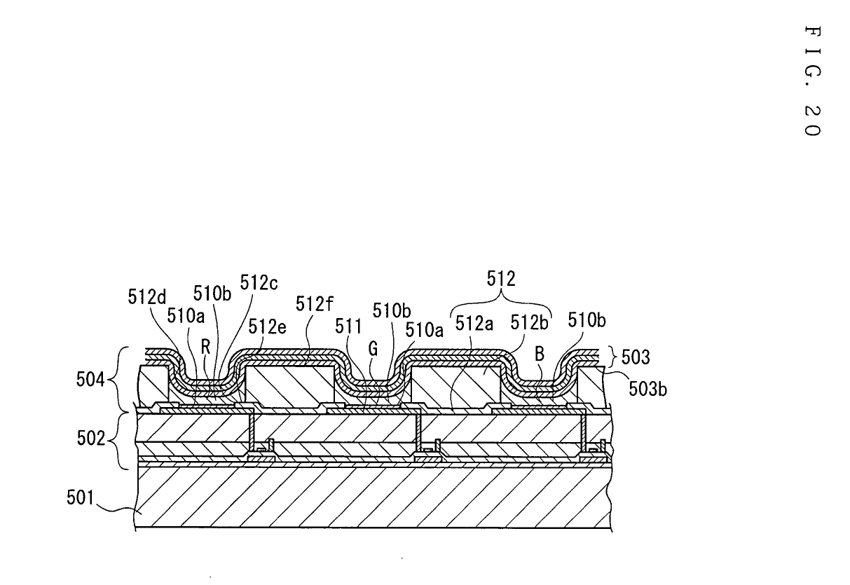

The photo-functional layers (the hole injection/transport layers 510a and the light-emitting layers 510b) 510 are formed using the inkjet method (S16). Then the counter electrode (negative electrode) 503 is formed (S17: see FIG. 20. etc.). The counter electrode 503 is formed by stacking a plurality of materials. The counter electrode may be formed by applying and drying the functional liquid in which the ITO particulates are dispersed using the deposition method, etc., similarly to the pixel electrodes 511. In this way, the element layer 20 is formed on the substrate 501 through S12 to S17.

Next, the sealing layer 30 is formed (S18) to cover the substrate 501 and the element layer 20. In this case, the sealing layer 30 is formed by applying an ultraviolet curable resin which is cured with the optical energy (ultraviolet ray). Thereafter, the extension of the substrate 501 (the organic EL display device 10) is performed (S19) to a desired size by using the extension apparatus 60 (see FIGS. 4 and 5). After the extension, the sealing layer 30 is cured (S20) by applying the ultraviolet ray to the organic EL display device 10. Thereafter, by performing the cutting-out (dicing) process, the bonding process, the finishing process, the characteristic inspection process, etc. to the mother board W, the organic EL display device 10 is completed.

Now, the aforementioned manufacturing process will be sequentially described with reference to the structural schematics. FIGS. 9 and 10 show the step of forming the bank portions 512 after forming the pixel electrodes 511. In the bank portion forming step, the bank portions 512 having an opening portion 512g are formed by stacking inorganic bank layers 512a and organic bank layers 512b at predetermined positions on the circuit element layer 502 and the pixel electrodes 511 previously formed on the substrate 501.

First, in the step of forming the inorganic bank layers 512a, as shown in FIG. 9, the inorganic bank layers 512a are formed on a second interlayer insulating film 544b and the pixel electrodes 511 in the circuit element layer 502. In this case, the inorganic bank layers 512a are formed out of an inorganic film made of SiO₂, TiO₂, etc., and are formed using the CVD method, the coating method, the sputtering method, the deposition method, etc.

Next, lower opening portions 512c are provided at positions corresponding to the positions where electrode surfaces 511a of the electrodes 511 are located, by patterning the inorganic film through the etching process, etc. At that time, it is preferable that the inorganic bank layers 512a may be formed to overlap with the circumferential portions of the electrodes 511. In this way, by forming the inorganic bank layers 512a such that the circumferential portions (parts) of the electrodes 511 and the inorganic bank layers 512a overlap with each other, it is possible to control light-emitting areas of the light-emitting layers 510b.

Next, in the step of forming the organic bank layers 512b, as shown in FIG. 10, the organic bank layers 512b are formed on the inorganic bank layers 512a. By etching the organic bank layers 512b using the photolithography method, etc., upper opening portions 512d of the organic bank layers 512b are formed. The upper opening portions 512d are provided at positions corresponding to the electrode surfaces 511a and the lower opening portions 512c.

As shown in FIG. 10, that the upper opening portions 512d may be formed to be larger than the lower opening portions 512c and smaller than the electrode surfaces 511a. As a result, first stacked portions 512e surrounding the lower opening portions 512c of the inorganic bank layers 512a are protruded toward the center of the electrodes 511 from the organic bank layers 512b. In this way, by allowing the upper opening portions 512d and the lower opening portions 512c to communicate with each other, openings 512g penetrating the inorganic bank layers 512a and the organic bank layers 512b are formed.

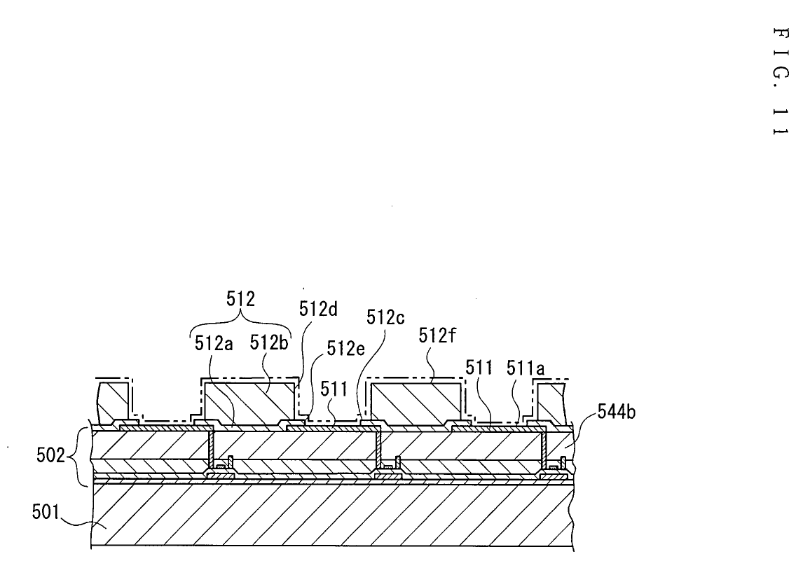

The surface treatment process may be further formed as needed. Here, the surface treatment process includes the preliminary heating process, the lyophilic process of processing top surfaces 512f of the bank portions 512, walls of the openings 512g and the electrode surfaces 511a of the pixel electrodes 511 to be lyophilic, a lyophobic process of processing the top surfaces 512f of the organic bank layers 512b and the walls of the upper opening portions 512d to be lyophobic, and the cooling process. In the lyophilic process, as shown in FIG. 11, the electrode surfaces 511a of the pixel electrodes 511, the first stacked portions 512e of the inorganic bank layers 512a, and the walls and the top surfaces 512f of the upper opening portions 512d of the organic bank layers 512b are processed to be lyophilic.

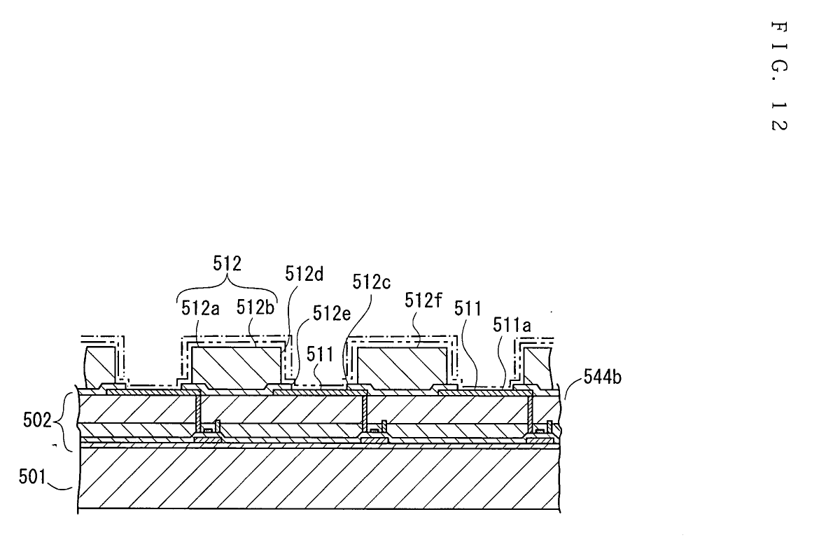

In the lyophobic process, the plasma process (CF₄ plasma process) using 4-fluoromethane as the process gas is performed in the atmosphere. As shown in FIG. 12, the walls of the upper opening portions 512d and the top surfaces 512f of the organic bank layers are processed to be lyophobic, through the CF₄ plasma process. Through the lyophobic process, fluorine groups are introduced into the respective surfaces and a lyophobic property is given thereto. In FIG. 12, the areas exhibiting the lyophobic property are denoted by dashed lines. The bank portion forming step and the surface treatment step described here may be omitted.

Next, in the photo-functional layer forming step, the hole injection/transport layers 510a and the light-emitting layers 510b are formed on the pixel electrodes 511 by using the inkjet method. One pixel electrode 511, one hole injection/transport layer 510a and one light-emitting layer 510b constitute one light-emitting element. The photo-functional layer forming step includes four steps. That is, there are included a first functional liquid droplet ejecting step of ejecting a first composition to form the hole injection/transport layers 510a on the pixel electrodes 511, a hole injection/transport layer forming step of drying the ejected first composition and forming the hole injection/transport layers 510a on the pixel electrodes 511, a second functional liquid droplet ejecting step of ejecting a second composition to form the light-emitting layers 510b on the hole injection/transport layers 510a, and a light-emitting layer forming step of drying the ejected second composition and forming the light-emitting layers 510b on the hole injection/transport layers 510a.

First, in the first functional liquid droplet ejecting step, the first composition containing the hole injection/transport layer forming material is ejected on the electrode surfaces 511a by using the inkjet method (the functional liquid droplet ejecting method).

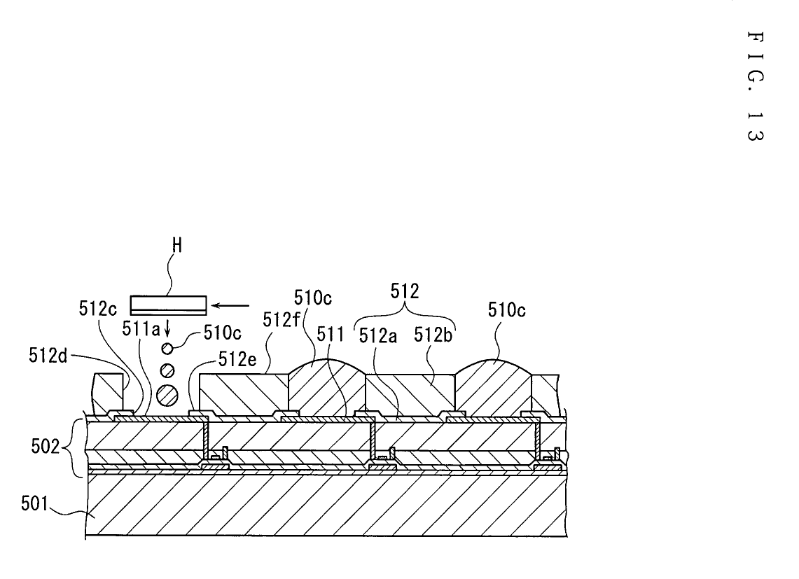

As shown in FIG. 13, the functional liquid droplet ejecting heads H are filled with the first composition containing the hole injection/transport layer forming material, the ejecting nozzles of the functional liquid droplet ejecting heads H are allowed to face the electrode surfaces 511a positioned in the lower opening portions 512c, and the first composition droplets 510c of which the liquid amount per droplet is controlled are ejected onto the electrode surfaces 511a from the ejecting nozzles while relatively moving the functional liquid droplet ejecting heads H and the substrate 501. As the hole injection/transport layer forming material, the same material may be used every light-emitting layer 510b of R, G and B, and different material may be used every the light-emitting layer 501b.

As shown in FIG. 13, the ejected first composition droplets 510c are diffused on the electrode surfaces 511a and the first stacked portions 512e, and fill the lower and upper opening portions 512c, 512d. The amount of the first composition ejected on the electrode surfaces 511a is determined in accordance with sizes of the lower and upper opening portions 512c, 512d, a thickness of the hole injection/transport layers 510a, concentration of the hole injection/transport layer forming material in the first composition, etc. The first composition droplets 510c may be ejected once on the electrode surfaces 511a, and may be ejected several times on the same electrode surfaces.

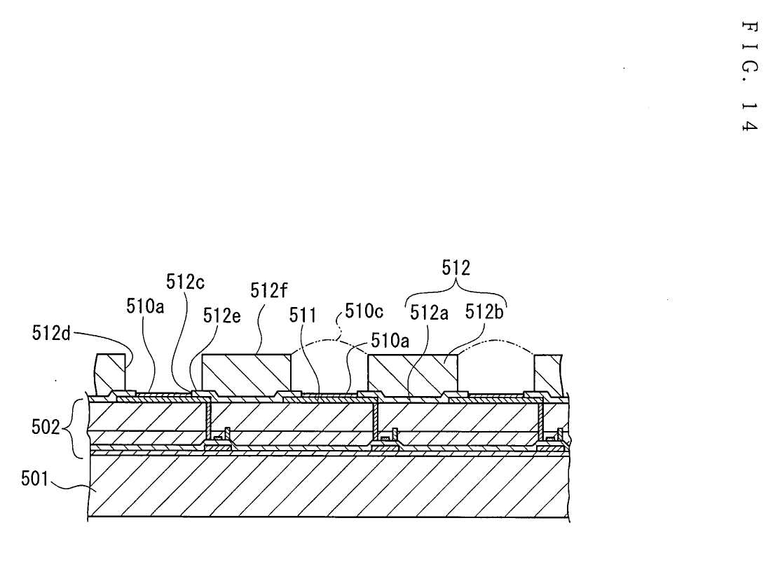

Next, in the hole injection/transport layer forming step, as shown in FIG. 14, the hole injection/transport layers 510a are formed on the electrode surfaces 511a, by drying and heating the first composition after the ejection to vaporize a polar solvent contained in the first composition. When the dry process is preformed, the vaporization of the polar solvent contained in the first composition droplets 510c occurs mainly in the vicinity of the inorganic bank layers 512a and the organic bank layers 512b, and the hole injection/transport layer forming material is condensed and extracted with the vaporization of the polar solvent.

Accordingly, as shown in FIG. 14, the vaporization of the polar solvent occurs on the electrode surfaces 511a through the dry process. Thus flat portions 510a made of the hole injection/transport layer forming material are formed on the electrode surfaces 511a. Since the vaporization speed of the polar solvent is almost uniform on the electrode surfaces 511a, the hole injection/transport layer forming material is uniformly condensed on the electrode surfaces 511a, so that the flat portions 510a having a uniform thickness are formed.

Next, in the second functional liquid droplet ejecting step, the second composition containing the light-emitting layer forming material is ejected on the hole injection/transport layers 510a by using the inkjet method (the functional liquid droplet ejecting method). In the second functional liquid droplet ejecting step, in order to reduce or prevent the hole injection/transport layer 510a from being remelted, a nonpolar solvent not dissolving the hole injection/transport layers 510a is used as a solvent of the second composition used to form the light-emitting layers.

However, since the hole injection/transport layers 510a has a low lyophilic property with the nonpolar solvent, the hole injection/transport layers 510a and the light-emitting layers 510b may not be in close contact with each other, or the light-emitting layers 510b may not be applied uniformly, even if the second composition containing the nonpolar solvent is ejected on the hole injection/transport layers 510a. Therefore, in order to enhance the lyophilic property of the surfaces of the hole injection/transport layers 510a with the nonpolar solvent and the light-emitting layer forming material, it is preferable that a surface reforming process may be performed before forming the light-emitting layers 510b.

The surface reforming process will be described. The surface reforming process is performed by applying and drying a surface reforming solvent, which is a solvent equal to or close to the nonpolar solvent of the first composition used form forming the light-emitting layers, on the hole injection/transport layers 510a by using the inkjet method (the functional liquid droplet ejecting method), the spin coating method, or the dip method.

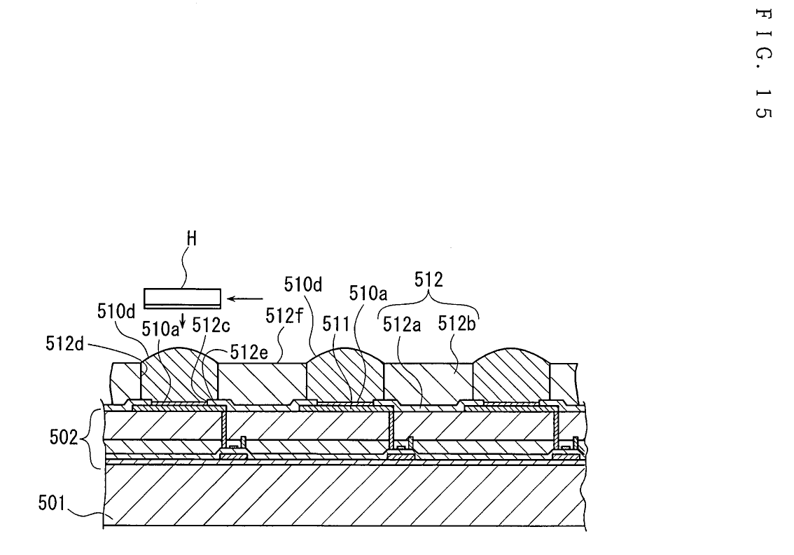

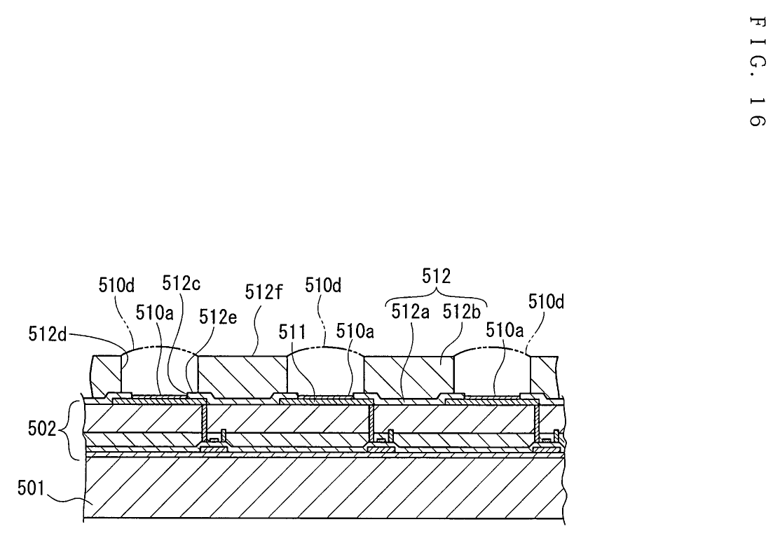

For example, the application using the inkjet method is performed, as shown in FIG. 15, by filling the functional liquid droplet ejecting heads H with the surface reforming solvent, allowing the ejecting nozzles of the functional liquid droplet ejecting heads H to face the substrate 501 (that is, the substrate on which the hole injection/transport layers 510a are formed), and ejecting the surface reforming solvent 510d on the hole injection/transport layers 510a from the ejecting nozzles while relatively moving the functional liquid droplet ejecting heads H and the substrate 501. Then, as shown in FIG. 16, the surface reforming solvent 510d is dried.

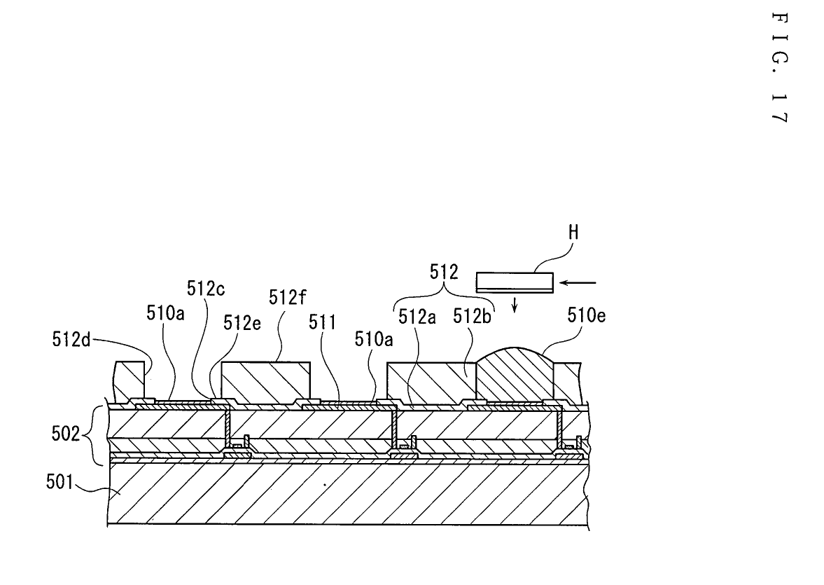

Next, in the second functional liquid droplet ejecting step, the second composition containing the light-emitting forming material is ejected on the hole injection/transport layers 510a by using the inkjet method (the functional liquid droplet ejecting method). As shown in FIG. 17, the second composition droplets 510e are ejected on the hole injection/transport layers 510a, by filling the functional liquid droplet ejecting heads H with the second composition containing the blue (B) light-emitting forming material, allowing the ejecting nozzles of the functional liquid droplet ejecting heads H to face the hole injection/transport layers 510a positioned in the lower and upper opening portions 512c, 512d, and ejecting the second composition droplets 510e, of which the liquid amount per droplet is controlled, from the ejecting nozzles while relatively moving the functional liquid droplet ejecting heads H and the substrate 501. It is preferable that the nonpolar solvent cannot dissolve the hole injection/transport layers 510a. As a result, it is possible to apply the second composition without remelting the hole injection/transport layers 510a.

As shown in FIG. 17, the ejected second composition droplets 510e are diffused on the hole injection/transport layers 510a and are filled in the lower and upper opening portions 512c, 512d. The second composition droplets 510emay be ejected only once, and may be ejected several times on the same hole injection/transport layers 510a. In this case, the amount of the second composition may be equal every time, and may be changed every time.

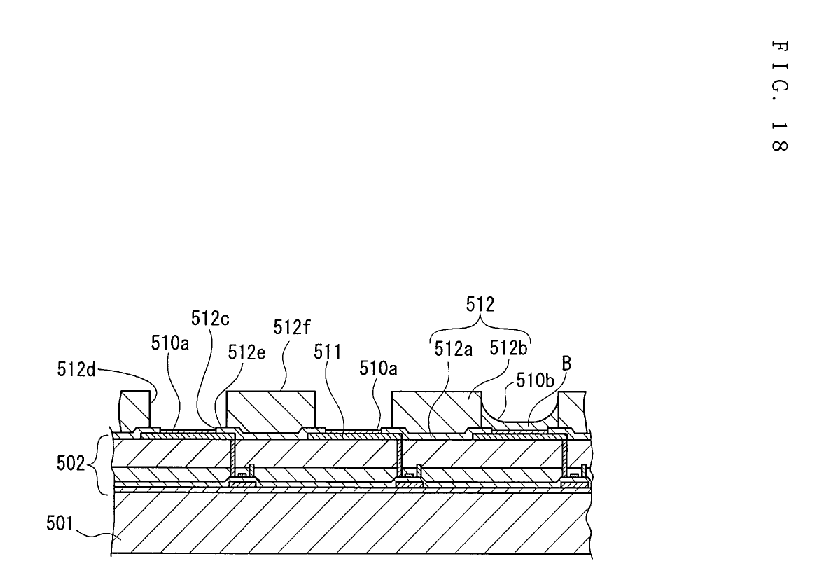

Next, in the light-emitting layer forming step, by performing the dry process and the heating process after the ejecting the second composition, the light-emitting layers 510b are formed on the hole injection/transport layers 510a. In the dry process, by drying the second composition after the ejection to vaporize the nonpolar solvent contained in the second composition, the blue (B) light-emitting layers 510b shown in FIG. 18 are formed.

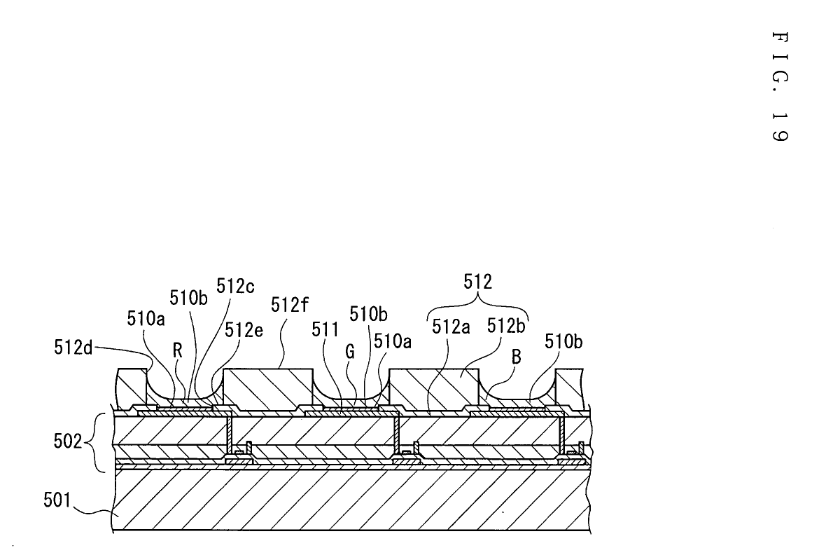

Subsequently, as shown in FIG. 19, similarly to the blue (B) light-emitting layers 510b, the red (R) light-emitting layers 510b are formed, and finally the green (G) light-emitting layers 510b are formed. The order of forming the light-emitting layers 510b is not limited to this order, but the light-emitting layers may be formed in any order.

Next, in the counter electrode forming step, as shown in FIG. 20, the negative electrode (the counter electrode) 503 is formed on the whole surface of the light-emitting layers 510b and the organic bank layers 512b. The negative electrode 503 maybe formed by applying ITO, and may be formed by stacking a plurality of materials.

For example, it is preferable that a material having a small work function such as Ca, Ba, etc. may be formed at a side close to the light-emitting layers 510b, and depending upon materials, LiF (lithium fluoride) may be formed as its lower layer. A material having a work function larger than the material at the lower side may be formed at the upper side (the sealing layer side). The negative electrode (the negative electrode layer) 503 may be formed using, for example, the deposition method, the sputtering method, the CVD method, etc. The negative electrode may be formed using the deposition method, so that it is possible to reduce or prevent thermal damages of the light-emitting layers 510b.

LiF may be formed only on the light-emitting layers 510b, and may be also formed only on the blue (B) light-emitting layers 510b. In this case, an upper negative electrode layer 503b made of LiF is in contact with the red (R) light-emitting layers 501b and the green (G) light-emitting layers 510b. An Al film, an Ag film, etc. formed using the deposition method, the sputtering method, the CVD method, etc. may be used as a top layer of the negative electrode 503. In order to reduce or prevent oxidation, a protective layer made of SiO₂, SiN, etc. may be provided on the negative electrode 503.

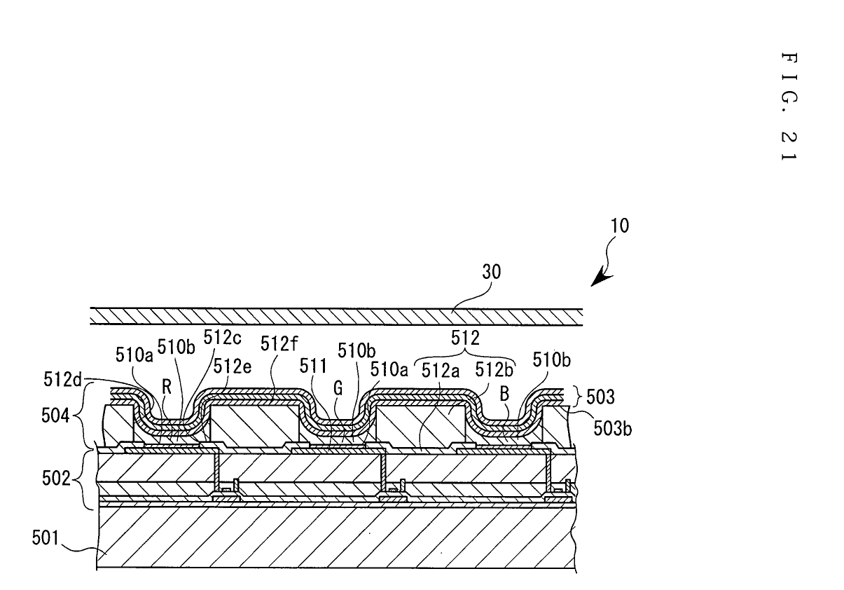

Finally, in the sealing-layer forming step shown in FIG. 21, the sealing layer 30 made of an ultraviolet curable resin is stacked on the display element layer 504 in an inert gas atmosphere of nitrogen, argon, helium, etc. The sealing process may be performed in the inert gas atmosphere of nitrogen, argon, helium, etc. It is not preferable that the sealing process is performed in the atmosphere, in that in a case where defects such as pin holes, etc. have occurred in the negative electrode 503, water or oxygen may permeate the negative electrode 503 through the defective portions to oxidize the negative electrode 503.

Finally, the wires of the flexible substrate 50 are connected to the negative electrode 503, and the wires of the circuit element layer 502 are connected to the driving IC 51. Thereafter, the mother board W is extended by the extension apparatus 60, and the sealing layer 30 is cured by applying the ultraviolet ray to the sealing layer with an ultraviolet lamp 98, so that the organic EL display device 10 according to this exemplary embodiment is obtained. In this way, by forming the sealing layer 30, the gas barrier property can be enhanced. Since the sealing layer 30 is cured after shrinking the mother board W, the extension of the substrate 501 is not hindered by the sealing layer 30.

The pixel electrodes 511, the negative electrode (the counter electrode) 503 and the bank portions 512 (the inorganic bank layers 512a and the organic bank layers 512b) may be formed using the inkjet method. That is, the pixel electrodes 511, etc. are formed, respectively, by introducing a predetermined functional liquid into the functional liquid droplet ejecting heads H and then ejecting the functional liquid from the functional liquid droplet ejecting heads H (including the dry process). In this way, by forming the respective layers using the inkjet method, it is possible to efficiently manufacture the organic EL display device 10 without performing the complex process, such as a case using the photolithography method and without wasting the materials.

The substrate 501 may be made of the elastic material exhibiting the irreversibility with the optical energy, such as ultraviolet ray, etc., or the elastic material exhibiting the irreversibility with the thermal energy. In this case, it is preferable that the optical energy or the thermal energy may be applied after extending the mother board W.

The sealing layer 30 may be made the thermosetting resin (thermosetting film) which is cured with the thermal energy, in place of the ultraviolet curable resin. In this case, the sealing layer 30 is heated with a heater, etc. in place of the ultraviolet ray, after extending the mother board W.

The pixel electrodes 511 have made of ITO, but may be made of a material obtained by mixing 30 or more volume percentages of carbon nano tubes with the elastic material. According to this construction, it is possible to secure the conductivity, and the mixed material can be used as the transparent electrode.

As described above, according to this exemplary embodiment, since the substrate 501 is made of the irreversible elongate material, and the element layer 20 formed on the substrate 501 is made of the elastic material and has the adhesive property to the substrate 501, it is possible to manufacture the organic EL display device 10 having a size larger than the original substrate 501 by extending the substrate 501 after forming the element layer 20. Therefore, in a case of manufacturing the large organic EL display device 10, it is possible to reduce or prevent the enlargement of a production line or the manufacturing apparatus (the functional liquid droplet ejecting apparatus 1) and the resultant increase in cost. Further, since the element layer 20 is formed on the substrate 501 having a size smaller than a desired size, it is possible to rapidly perform the application to one sheet of substrate 501, for example, using an inkjet method, so that it is possible to reduce or prevent the nozzles from being dried. Furthermore, since the arrangement of polymer constituting the photo-functional layer 110 can be aligned through the extension, it is possible to enhance the mobility of electrons or holes.

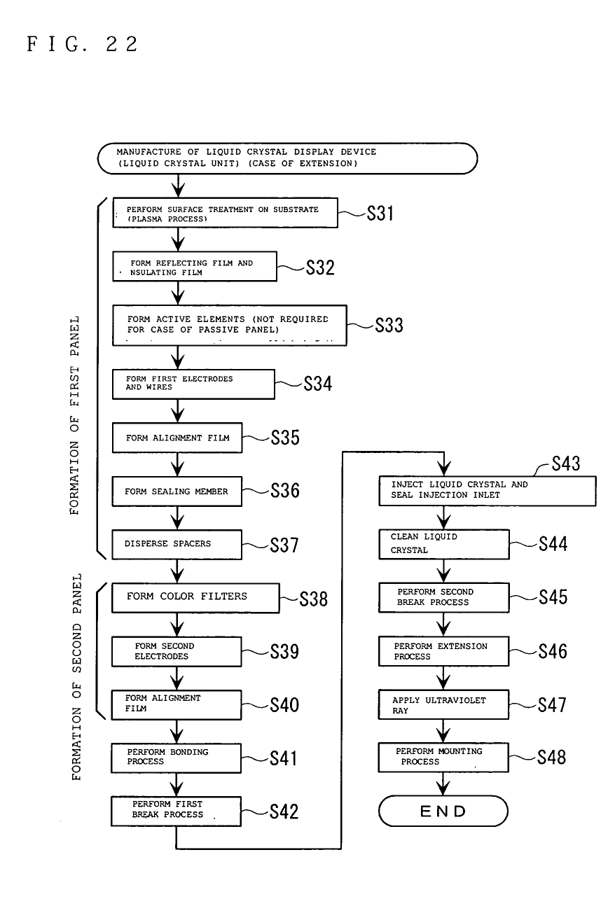

Next, a second exemplary embodiment of the present invention will be described with reference to FIGS. 22 to 25. In this exemplary embodiment, a method of manufacturing a liquid crystal display device (a liquid crystal panel) 600 will be described, where the display device having a desired size is manufactured, similarly to the first exemplary embodiment, by forming the element layer 20 on the substrate 501 having a size smaller than the target size and extending the substrate. In this exemplary embodiment, a transflective liquid crystal display device 600 to perform a full color display in a simple matrix type is exemplified. Furthermore, in this exemplary embodiment, descriptions of the manufacturing process and structure of the display device 600 will be omitted.

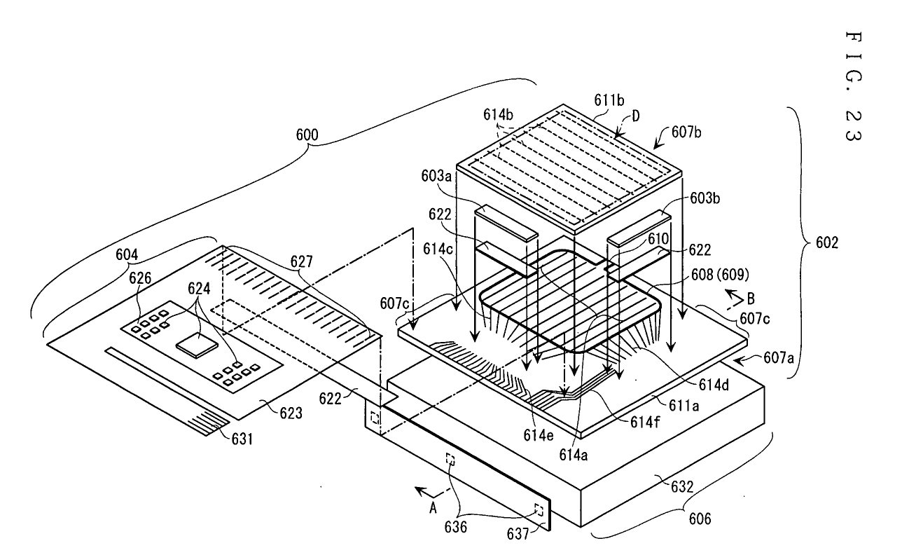

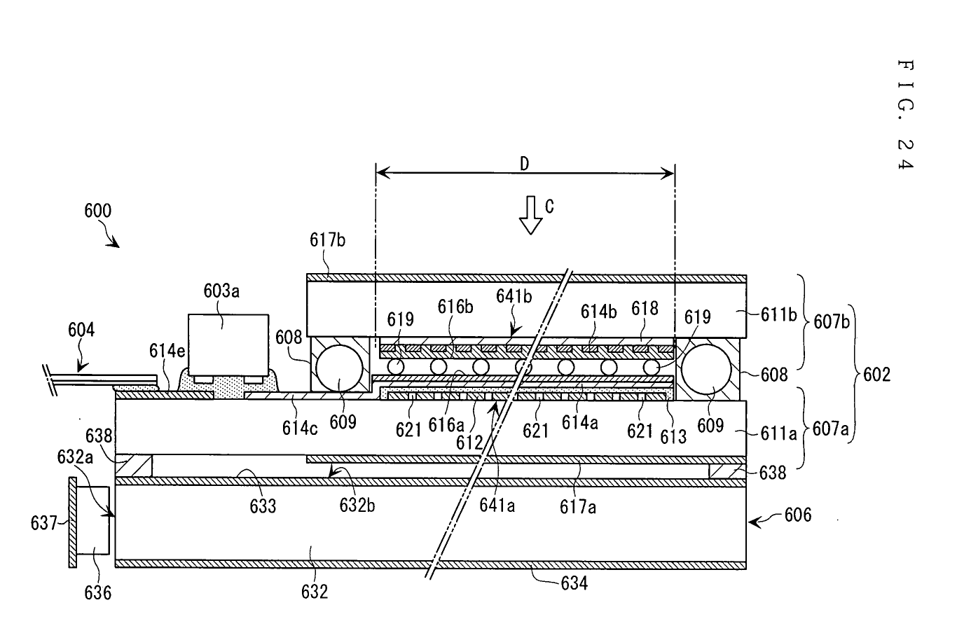

FIG. 22 is a flowchart illustrating the method of manufacturing the liquid crystal display device 600, FIG. 23 is an schematic of the liquid crystal display device 600. FIG. 24 shows a sectional schematic of the liquid crystal display device 600 taken along plane A-B of FIG. 22. As shown in FIG. 22, the liquid crystal display device 600 is manufactured by forming a first panel 607a and a second panel 607b, respectively, and adhesively bonding them. Therefore, a step of forming the first panel is first described. In the first panel forming step, the surface treatment process (the plasma process) is performed on a mother board W for the first panel 607a made of the ultraviolet curable resin (S31). This surface treatment process is similar to the first exemplary embodiment, and thus its description is omitted. Next, a reflecting film 612 is formed using the photolithography method, etc., an insulating film 613 is formed (S32) using suitable film forming methods, and active elements (not shown) are formed (S33) using the inkjet method, etc. in a case of an active panel. Next, first electrodes and various wires (drawn wires 614c, wires 614e, 614f, etc.) are formed (S34) using the photolithography method, etc. An alignment film 616a is formed (S35) on the first electrodes 614a through application, printing, etc.

Next, a seal member 608 is formed (S36) in a ring shape, for example, through screen printing, etc., and circular spacers 119 are dispersed thereon (S37). As a result, the large-area mother board W for the first panel having a plurality of panel patterns corresponding to the first panel 607a of the liquid crystal panel 602 is formed.

Next, the second panel 607b is formed. In the second panel forming step, a plurality of color filter 618 of the liquid crystal display device 600 are formed on a mother board W for the second panel 607b made of the ultraviolet curable resin (S38). The color filters 618 are formed by forming the respective color filter elements of R, G, B using the functional liquid droplet ejecting apparatus 1. Since the related art methods can be used as the method of forming the color filters 618 using the inkjet method, detailed descriptions thereof will be omitted.

Next, the second electrodes 614b are formed (S39) using the photolithography method, etc., and an alignment film 616b is formed (S40) through the application, the printing, etc. In this way, the large-area mother board W for the second panel having a plurality of panel patterns corresponding to the second panel 607b of the liquid crystal panel 602 is formed. The first panel and the second panel may be formed simultaneously without using the order described above.

After forming the large-area mother boards W for the first panel 607a and the second panel 607b through the above processes, the mother boards W are aligned with the sealing member 608 interposed therebetween, and then are adhesively bonded (S41). As a result, a hollow panel structure, which includes panel portions corresponding to a plurality of liquid crystal panels and to which the liquid crystal is not yet injected, is obtained.

Next, scribed grooves, that is, cutting grooves, are formed at predetermined positions of the completed hollow panel structure, and the panel structure is broken, that is, cut out, using the scribed grooves as a reference (S42: first break). As a result, a liquid injecting inlet 110 (see FIG. 23) of the sealing member 608 in each liquid crystal panel portion is exposed externally, thereby forming a so-called rectangular hollow panel structure.

Thereafter, the liquid crystal L is injected into each liquid crystal panel portion through the exposed liquid crystal injecting inlet 110. Then the liquid crystal injecting inlet 110 is sealed with resin, etc. (S43). A general liquid crystal injecting process is performed, for example, by storing the liquid crystal in a storage vessel, putting the storage vessel storing the liquid crystal and the rectangular hollow panels into a chamber, making the chamber in vacuum, immersing the rectangular hollow panels into the liquid crystal within the chamber, and then exposing the chamber to the atmosphere. At that time, since the inner space of the hollow panel is in vacuum, the liquid crystal pressed with the atmospheric pressure is introduced into the panel through the liquid crystal injecting inlet. Since the liquid crystal is attached around the liquid crystal panel structure after injecting the liquid crystal, the rectangular panel after injecting the liquid crystal is subjected to a cleaning process (S44).

Thereafter, by forming again scribed grooves at predetermined positions of the rectangular mother boards W having been subjected to the liquid crystal injecting process and the cleaning process, and then cutting out the rectangular panel using the scribed grooves as a reference, the rectangular panels are separated into individual liquid crystal panels (S45: second break). Next, the individual liquid crystal panels 602 manufactured are extended using the extension apparatus 60 (S46). Through this extension process, the initial alignment of liquid crystal molecules is determined. Thereafter, by applying the ultraviolet ray, the substrates 611a, 611b for the first panel 607a and the second panel 607b are cured (S47).

Then, liquid crystal driving ICs 603a, 603b are mounted on the liquid crystal panel 602 having been subjected to the application of ultraviolet ray, a lighting unit 606 is mounted thereon as a backlight, and an FPC (Flexible Printed Circuit) 604 is connected thereto, thereby completing the liquid crystal display device 600 (electronic apparatus) (S48).

Next, a structure of the liquid crystal display device 600 manufactured through the aforementioned manufacturing processes will be described. As shown in FIG. 23, the liquid crystal display device 600 is constructed by fitting the liquid crystal driving ICs 603a and 603b as semiconductor chips to the liquid crystal panel 602, connecting the FPC (Flexible Printed Circuit) 604 as a wire connecting element to the liquid crystal panel 602, and providing the lighting unit 606 as the backlight at the rear side of the liquid crystal panel 602.

The liquid crystal panel 602 is formed by adhesively bonding the first panel 607a and the second panel 607b with the sealing member 608 therebetween. The sealing member 608 is formed by attaching an epoxy resin in a ring shape on an inner surface of the first panel 607a or the second panel 607b, for example, through the screen printing, etc. As shown in FIG. 24, the electrical conductive material 609 made of conductive material and having a circular shape or a cylindrical shape is dispersed inside the sealing member 608.

The first panel 607a is made of the ultraviolet curable resin having the elongate property and exhibiting the irreversibility with the ultraviolet ray. The reflecting film 612 is formed on an inner surface (an upper surface in FIG. 24) of the first panel 607a, and the insulating film 613 is stacked thereon.

The first electrodes 614a are formed thereon in a stripe shape as seen along a direction of an arrow C (see FIG. 23), and the alignment film 616a is formed thereon. A polarizing plate 617a is formed on an outer surface (a lower surface in FIG. 24) of the substrate 611a through the adhesive bonding, etc.

In the first panel 607a, the reflecting film 612, the insulating film 613, the first electrodes 614a, the alignment film 616a, the liquid crystal L, etc. constitute the element layer 641a, and the element layer 641a has a sufficient adhesive property to the substrate 611a. The elements constituting the element layer 641a are all made of the elastic material, and are extended with the extension of the substrate 611a while maintaining the same arrangement.

The second panel 607b is made of the ultraviolet curable resin, similarly to the first panel 607a, and the color filters 618 are formed on an inner surface (a lower surface in FIG. 24) of the substrate 611b by using the functional liquid droplet ejecting apparatus 1. The second electrodes 614b are formed thereon in a direction perpendicular to the first electrodes 614a and in a stripe shape as seen along a direction of an arrow D (see FIG. 2), and the alignment film 616b is formed thereon.

A polarizing plate 617b is formed on an outer surface (an upper surface in FIG. 24) of the substrate 611b through the adhesive bonding, etc.

In the second panel 607b, the color filters 618, the second electrodes 614b, the alignment film 616b, the liquid crystal L, etc. constitute the element layer 641b, and the element layer 641b has a sufficient adhesive property to the substrate 611b. The elements constituting the element layer 641b are all made of the elastic material, and are extended with the extension of the substrate 611a while maintaining the same arrangement.

As shown in FIG. 24, the liquid crystal such as STN (Super Twisted Nematic) liquid crystal L is injected into a gap, that is, a so-called cell gap, surrounded with the first panel 607a, the second panel 607b and the sealing member 608. Minute circular spacers 619 (circular resin beads having a diameter of about 3 microns) are dispersed on the inner surface of the first panel 607a or the second panel 607b. A thickness of the cell gap is kept uniform due to existence of the spacers 619 in the cell gap.

The first electrodes 614a and the second electrodes 614b are arranged to be perpendicular to each other. The intersections thereof are arranged in a dot matrix shape as seen in the direction of the arrow C. Each intersection in the dot matrix shape constitutes one pixel element. The color filters 618 are formed such that the respective color elements of R (red), G (green), B (blue) are arranged in a predetermined pattern, such as a stripe arrangement, a delta arrangement, etc. as seen in the direction of the arrow C. The one pixel element corresponds to one of R, G and B, and three color pixel elements of R, G and B constitute one pixel as one unit.

By allowing the plurality of pixels arranged in the dot matrix shape to selectively emit light, images, such as characters, numerals, etc. are displayed on the outer surface of the second panel 607b of the liquid crystal panel 602. In this way, the areas in which the images are displayed are the effective pixel areas, and the flat rectangular area indicated by the arrow D is the effective display area.

The reflecting film 612 is made of a light-reflecting material, such as APC alloy, Al (aluminum), etc., and openings 621 are formed at positions corresponding to the pixel elements which are the intersections of the first electrodes 614a and the second electrodes 614b. The openings 621 are arranged in the same dot matrix shape as the pixel elements as seen in the direction of the arrow C.

The first electrodes 614a and the second electrodes 614b are made of, for example, ITO which is a transparent conductive material. The alignment films 616a, 616b are formed by attaching a polyimide resin in a film shape having a uniform thickness. The alignment films 616a and 616b determines the initial alignment of liquid crystal molecules on the surfaces of the first panel 607a and the second panel 607b in accordance with the extension direction. Therefore, in this exemplary embodiment, the extension may be performed only in the one-dimensional direction or by two steps as shown in FIG. 7, in place of performing the extension simultaneously in the two-dimensional directions as shown in FIG. 6. According to this construction, it is possible to surely align the liquid crystal molecules.

The first panel 607a has an area larger than that of the second panel 607b, and the first panel 607a has a substrate protruded portion 607c protruded outwardly from the second panel 607b when the substrates are adhesively bonded through the sealing member 608. Various wires, such as drawn wires 614c extending from the first electrodes 614a, drawn wires 614d electrically connected to the second electrodes 614b on the second panel 607b through the conductive material 609 existing in the sealing member 608, wires 614e connected to input bumps, that is, input terminals, of the liquid crystal driving IC 603, wires 614f connected to input bumps of the liquid crystal driving IC 603b, etc. are formed in proper patterns on the substrate protruded portion 607c. The drawn wires 614c, the wires 614e and the wires 614f are formed by dispersing metal particulates in the conductive polymer, so that it is possible to reduce or prevent short-circuits due to the extension while securing the conductivity.

The liquid crystal driving IC 603a and the liquid crystal driving IC 603b are bonded and fitted to the substrate protruded portion 607c through an ACF (Anisotropic Conductive Film) 622. Through the conductive particles contained in the ACF 622, the input bumps of the liquid crystal driving ICs 603a and 603b and the wires 614e and 614f are electrically connected to each other. The output bumps of the liquid crystal driving ICs 603a and 603b and the drawn wires 614c and 614d are electrically connected to each other.

The FPC 604 has an elastic resin film 623, circuits 626 including chip components 624, and connection terminals 627 (see FIG. 23). The circuits 626 are directly mounted on a surface of the resin film 623 by using a soldering method or other electrical connecting methods. A portion of the FPC 604 in which the connection terminals 627 are formed is connected through the ACF 622 to portions of the first panel 607a in which the wires 614e and the wires 614f are formed. By operation of the conductive particles contained in the ACF 622, the wires 614e and 614f at the substrate side and the connection terminals 627 at the FPC side are electrically connected.

External connection terminals 631 are formed at one end of the opposite side of the FPC 604, and the external connection terminals 631 are connected to an external circuit, not shown. The liquid crystal driving ICs 603a and 603b are driven on the basis of signals transmitted from the external circuit, scanning signals are supplied to one of the first electrodes 614a and the second electrodes 614b, and data signals are supplied to the other thereof. As a result, the pixel elements arranged in the dot matrix shape in the effective display area V are voltage-controlled in a pixel unit. Thus the alignment of the liquid crystal L is controlled in a pixel element unit.

The lighting unit 606 functions as a backlight, and has a light guiding member 632 made of acryl resin, etc., a diffusing sheet 633 provided on a light output surface 632b of the light guiding member 632, a reflecting sheet 634 provided on a surface of the light guiding member 632 opposite to the light output surface 632b, and an LED (Light Emitting Diode) 636 as a light emitting source.

The LED 636 is supported by an LED substrate 637, and the LED substrate 637 is fitted, for example, to a support portion (not shown) formed integrally with the light guiding member 632. By fitting the LED substrate 637 to a predetermined position of the support portion, the LED 636 is positioned at a position facing a light input surface 632a which is one end surface of the light guiding member 632. A reference numeral 638 denotes a buffer member to buffer impacts applied to the liquid crystal panel 602.

When the LED 636 emits light, the emitted light is input and guided through the light input surface 632a into the light guiding member 632, and is output externally as flat light through the diffusing sheet 633 from the light output surface 632b with being reflected from the reflecting sheet 634 or walls of the light guiding member 632 and propagating.

According to the above construction, in the liquid crystal display device 600 according to this exemplary embodiment, in a case where sufficient light intensity is obtained from external light, such as sunlight, indoor light, etc., the external light from the second panel 607b side is input to the inside of the liquid crystal panel 602, passes through the liquid crystal L, is reflected from the reflecting film 612, and then is supplied to the liquid crystal L again. As a result, the reflection type display is performed. On the other hand, in a case where the sufficient light intensity is not obtained from the external light, the LED emits light. Thus flat light is output from the light output surface 632b of the light guiding member 632, and the light is supplied to the liquid crystal L through the openings 621 formed in the reflecting film 612. As a result, the transmission type display is performed.

As described above, in the liquid crystal display device 600, since the first panel 607a and the second panel 607b are made of the irreversible elongate material (the ultraviolet curable resin), and the element layers 641a, 641b formed on the substrates 611a, 611b are all made of the elastic material and have the adhesive property to the substrates 611a, 611b, respectively, it is possible to manufacture the liquid crystal panel 602 having a size larger than the original substrates 611a, 611b by forming the first panel 607a and the second panel 607b, and then adhesively bonding and extending them. Therefore, in a case of manufacturing the large liquid crystal panel 602 (liquid crystal display device 600), it is possible to reduce or prevent the enlargement of a production line and the resultant increase in cost.

By adhesively bonding the first panel 607a and the second panel 607b having been divided into the respective chips, injecting the liquid crystal, and extending the display device 600, it is possible to align the liquid crystal molecules. Therefore, when forming the first panel 607a and the second panel 607b, it is possible to integrally align the alignment films, without performing the rubbing process individually after forming the alignment films 616a and 616b.

The first electrodes 614a, the second electrodes 614b, the drawn wires 614c, the wires 614e, 614f, etc. may be formed using the inkjet method. That is, by introducing a predetermined functional liquid into the functional liquid droplet ejecting heads H and ejecting the functional liquid from the functional liquid droplet ejecting heads H, the first electrodes 614a, etc. may be formed (this formation includes a dry process).

Next, a third exemplary embodiment of the present invention will be described. In the aforementioned exemplary embodiments, cases where the element layers 20, 641a, 641b (hereinafter, only the reference numeral 20 is described) are formed on the substrates 501, 611a, 611b (hereinafter, only the reference numeral 501 is described) having a size smaller than a desired size, respectively, have been described. However, in this exemplary embodiment, a case where the element layer 20 is formed on the substrate 501 having a size larger than a desired size, that is, a case where the display devices 10, 600 (hereinafter, only the reference numeral 10 is described) having a size smaller than the original substrate 501 through shrinking, will be described. This exemplary embodiment may be applied to any of the organic EL display device 10 and the liquid crystal display device 600.

In this case, the substrate 501 is made of a thermal-shrinking material exhibiting the shrinkage in response to thermal energy or a photo-shrinking material exhibiting the shrinkage in response to optical energy.

The element layer 20 formed on the substrate 501 is made of the elastic material similar to the aforementioned exemplary embodiments, and has the sufficient adhesive property to the substrate 501.

Therefore, by shrinking the substrate 501 after forming the element layer 20, it is possible to manufacture the display device 10 having a size smaller than the original substrate 501.

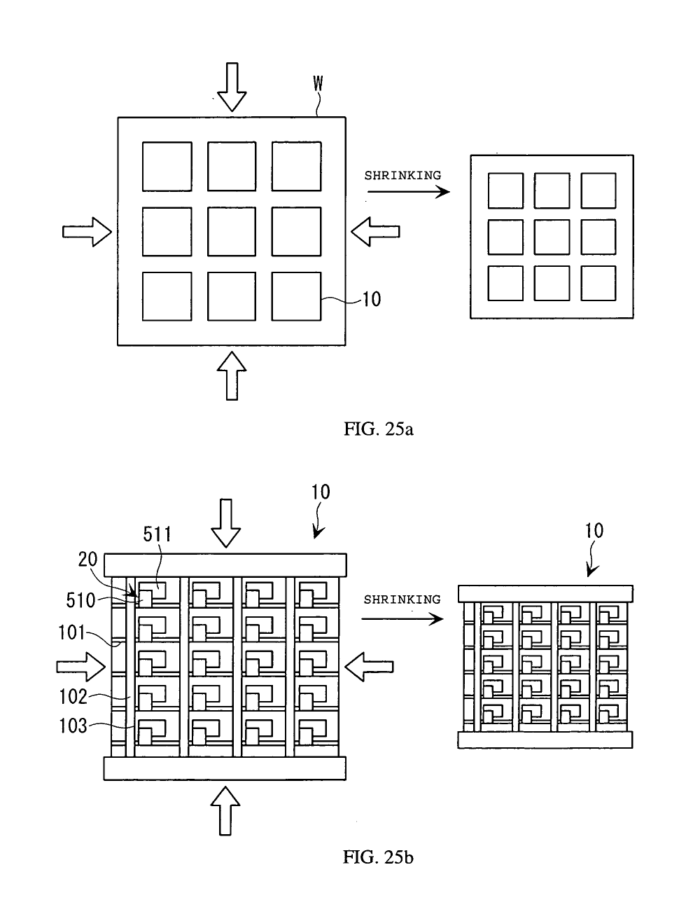

FIG. 25 shows the shrunk state of the display device 10, and as shown in the figure, the display device is shrunk with the same shrinking scale in the two-dimensional direction (the X-axis direction and the Y-axis direction). The shrinking may be performed one-dimensionally, and may be performed two-dimensionally by two steps. In this way, by shrinking the substrate 501 after forming the element layer 20, it is possible to easily manufacture the display device 10 having excellent display quality, even if the accuracy of the manufacturing apparatus (the functional liquid droplet ejecting apparatus 1) is not enhanced largely in forming the element layer 20. That is, when the elements (for example, the photo-functional layers 510, etc.) in the element layer 20 are formed using the inkjet method, it is necessary to accurately eject a predetermined amount (predetermined times) of functional liquid into the minute pixel areas. However, in this exemplary embodiment, since the functional liquid can be ejected in a state where the pixel areas are enlarged, it is possible to reduce errors of the ejecting positions (the ejection accuracy) as much.

Next, a fourth exemplary embodiment of the present invention will be described. In the third exemplary embodiment, a case where the display device 10 having a size smaller than the original substrate 501 is manufactured through shrinking has been described. However, in this exemplary embodiment, the substrate 501 is made of elastic material (a rubber film of polyurethane rubber, silicon rubber, etc.) which can be voluntarily shrunk. The element layer 20 is formed in the state (pre-extension process) where the substrate 501 is first fixed to the extended state thereof by the extension mechanism (which can perform the extension in the X-axis direction and/or the Y-axis direction) (see the extension apparatus shown FIG. 4). Then, after forming the element layer 20, the extension mechanism is released to restore the substrate 501 to its original size. This exemplary embodiment may be applied to any of the organic EL display device 10 and the liquid crystal display device 600. In this exemplary embodiment, the elements constituting the element layer 20 are all made of an elastic material, and the element layer 20 has the adhesive property to the substrate 501.

In this case, as the extension mechanism, an apparatus obtained by fitting the extension apparatus shown in FIG. 4 into the functional liquid droplet ejecting apparatus shown in FIG. 3 can be used, and for example, in the organic EL display device 10, the mother board W or the substrate 501 are fixed to the set table 21, by clipping the top portion and the bottom portion, or the edges of the mother board W or the substrate 501. In the state where the mother board W or the substrate 501 is not moved, the element layer 20 is formed, the sealing layer 30 made of the ultraviolet curable resin is formed thereon, and the extension mechanism is released to shrink the mother board or the substrate. Finally, by applying the ultraviolet ray, the sealing layer 30 is cured.

In a case where the element layer 20 is formed using the inkjet method, the functional liquid may be dried in the extended state the substrate 501, and then is shrunk. According to this construction, the functional liquid can be more rapidly dried, so that it is possible to reduce or prevent the non-uniformity in dry.

As a result, according to this exemplary embodiment, since the substrate 501 and the element layer 20 are all made of the elastic material, and the element layer 20 formed on the substrate 501 has the adhesive property to the substrate 501, it is possible to manufacture the display device 10 having a size smaller than the original substrate 501, by shrinking the substrate 501 after forming the element layer 20. Therefore, in a case where the element layer 20 is formed, for example, using the inkjet method, since the functional liquid can be ejected in the enlarged pixel areas, it is possible to manufacture the display device 10 having excellent display quality without enhancing the accuracy of the manufacturing apparatus. Since the substrate 501 is made of the elastic material which can be voluntarily shrunk, it is possible to easily shrink the substrate 501 without using a process causing chemical change in the substrate 501 material, etc.

In this exemplary embodiment, the substrate 501 is made of the elastic material which can be voluntarily shrunk, but in place, the substrate 501 may be made of the elastic material which can be shrunk with the thermal energy or the optical energy and exhibits the irreversibility with these energies. According to this construction, by finally giving the thermal energy or the optical energy, the substrate can be shrunk, and it is possible to finally obtain the stable display device 10. Specifically, in a case where the substrate 501 is made of the contractile ultraviolet curable resin similarly to the sealing layer 30, since both of the substrate 501 and the sealing layer 30 can be simultaneously cured by finally applying the ultraviolet ray, the process is simplified. The substrate 501 and the sealing layer 30 may be made of the thermosetting resin which is shrunk and cured with the thermal energy (heating). In this case, since both of the substrate 501 and the sealing layer 30 can be simultaneously cured through the heating process, the process is simplified.

In this case, a thermal-shrinking film, etc. may be used as the elastic material exhibiting the irreversibility with the thermal energy. In this case, the elastic material may be shrunk at a relatively low temperature, has a high shrinking rate, and decrease in strength due to the shrinking or the temperature is small. According to this construction, it is possible to more simply manufacture the stable display device 10.

In this exemplary embodiment, an extension mechanism capable of partially extending the substrate 501 may be used in place of the extension apparatus 60 (extension mechanism) capable of extending the whole substrate 501 as shown in FIGS. 4 and 5. In this case, for example, the active element portions may not be extended, only the wire portions may be extended, and the functional liquid may be applied to the wire portions in accordance with the extension (in accordance with the deformation rate corresponding to the positions) by using the functional liquid droplet ejecting apparatus 1.

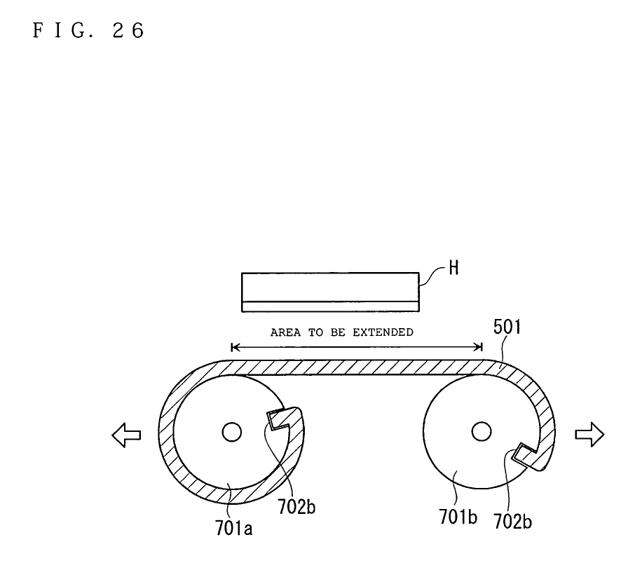

In this case, the extension mechanism shown in FIG. 26 may be used. That is, by locking an end of the substrate 501 to rollers 701a, 701b having chuck grooves 702a, 702b, respectively, winding the substrate about the rollers, and drawing the rollers 701a, 701b in an arrow direction, extension target area is extended. The wires, etc. are formed by ejecting the functional liquid to a flat portion as the extension target area from the functional liquid droplet ejecting heads H. In this case, where unevenness is generated in the extension target area due to the locking and winding of the substrate 501, the timing to eject the functional liquid from the functional liquid droplet ejecting heads H may be controlled in consideration of the unevenness. According to this construction, since the substrate 501 can be extended partially, it is possible to obtain the display device 10 having excellent display quality and to accomplish a decrease in size of the device even if the accuracy of the functional liquid droplet ejecting apparatus 1 is not largely enhanced.

As described above in the first to fourth exemplary embodiments, according to the display device, the electronic apparatus, and the method of manufacturing the display device, by making all the constituent elements of the display device 10 out of elongate materials, it is possible to form the element layer 20 (electrodes, hole injection/transport layers 510a, and light-emitting layers 510b) on the substrate 501 having a size smaller than a desired size (the first embodiment and the second embodiment). By using this construction, it is possible to reduce or prevent the growth in size of a production line and the resultant increase in cost.

In this case, since various wires connected to the electrodes are made of materials obtained by dispersing the metal particulates in the conductive polymer, it is possible to prevent short-circuits due to the extension with securing the conductivity.

By making all the constituent elements of the display device 10 out of contractile materials, it is possible to form the element layer on the substrate 501 having a size larger than a desired size (the third exemplary embodiment and the fourth exemplary embodiment). By using this construction, in a case where the element layer 20 is formed, for example, using the inkjet method, since the ejecting position accuracy (arriving accuracy) can be enhanced even if the accuracy of the manufacturing apparatus 1 is not largely enhanced, it is possible to manufacture the display device 10 having excellent display quality.

In this case, when the functional liquid ejected using the inkjet method is dried, the functional liquid can be more rapidly dried by maintaining the substrate 501 in the extended state (shrinking the substrate after drying it), so that it is possible to reduce or prevent the non-uniformity in drying.

In the case where the display device (the organic EL display device 10, the liquid crystal display device 600) is an active panel, the active elements are formed using the inkjet method, but the active elements formed using the photolithography method, etc. may be bonded (mounted) thereto. The method of bonding the active elements is disclosed in Japanese Unexamined Patent Application Publication No. 2001-51296, etc.

At that time, for example, in a case where the active elements are separated for every pixel, the active elements may be bonded to the substrate 501 before performing the extension process or the shrinking process to the substrate. In a case where the active elements of a plurality of pixels are concentrated, for example, in a case where the active elements of four pixels are concentrated, since the extension or the shrinking is not hindered by the bonded active elements by arranging the active elements at the intersections of the partition lines to partition the four pixels, the active elements can be bonded before performing the extension process or the shrinking process.

However, in this case, the active elements may be made of the elastic materials (organic thin film transistors), and wires thereof are made of the conductive material having an elasticity. In order to enhance the adhesive property to the substrate 501, the active elements may be bonded to the substrate 501 by using elastic adhesive. Of course, the active elements may be bonded after performing the extension process or the shrinking process to the substrate 501. In this construction, since the elasticity of the active elements need not be considered, it is possible to use the active elements having been used in the related art.

The elements (for example, the photo-functional layer 110, etc. of the organic EL display device 10) formed using the inkjet method in the above examples may be formed using a photolithography, etc. That is, the elements may be formed using any forming method, only if it employs elastic material.

In the first exemplary embodiment and the second exemplary embodiment, the display device 10 having a desired size is manufactured by extending the substrate 501, but in this case, high extension rate may cause cracks in the inorganic thin films (the pixel electrodes 511 made of ITO, the Ca layer of the negative electrode 503, the thin film for the gas barrier, etc.). For this reason, if such defects may be caused, the substrate may be extended before applying the inorganic thin film, or to deposit the inorganic thin film after forming the film in the extended state by using a film made of an elastic material and then shrinking it. The inorganic thin films may be replaced with organic thin films. According to this construction, the aforementioned defects cannot be caused.

The present invention is not limited to the organic EL display device 10 or the liquid crystal display device 600 described above, but may be applied to methods of manufacturing various display devices such as a PDP (Plasma Display Panel) device, an electrophoresis display device, an FED (Field Emission Display) device, etc.

As described above, in the display device, the electronic apparatus and the method of manufacturing the display device according to aspects of the present invention, since the element layer 20 (electrodes, hole injection/transport layer, and light-emitting layer) can be formed on a substrate having a size smaller than a desired size or on a substrate having a size larger than a desired size by allowing all the constituent elements of the display device to be made of elongate or contractile material, it is possible to reduce or prevent growth of a production line and the resultant increase in cost without deteriorating display quality.

1. A display device, comprising:
a substrate; and
an element layer having electrodes and a photo-functional layer formed above the substrate,
the substrate made of an irreversible elongate material, and
the element layer made of an elastic material and providing an adhesive property to the substrate.

2. A display device comprising:
a substrate; and
an element layer having electrodes and a photo-functional layer formed above the substrate,
the substrate made of a thermal-shrinking material exhibiting shrinkage in response to thermal energy or a photo-shrinking material exhibiting shrinkage in response to optical energy, and
the element layer made of an elastic material and providing an adhesive property to the substrate.

3. A display device, comprising:
an element layer having electrodes and a photo-functional layer is formed on the substrate,
both the substrate and the element layer made of an elastic material, and
the element layer providing an adhesive property to the substrate.

4. The display device according to claim 3, the substrate made of an autogenous shrinkable elastic material.

5. The display device according to claim 3, the substrate made of an elastic material exhibiting irreversibility in response to thermal energy or optical energy.

6. The display device according to claim 1, wires connected to the electrodes formed by dispersing metal particulates in a conductive polymer.

7. An electronic apparatus, comprising:
the display device according to claim 1, and a driving control device to drive and control the display device.

8. A method of manufacturing a display device in which an element layer having electrodes and a photo-functional layer is formed on a substrate, the substrate being made of an irreversible elongate material, and the element layer being made of an elastic material and having an adhesive property to the substrate, the method comprising:
forming the element layer on the substrate; and
extending the substrate so as to make the display device be a desired size, after forming the element layer.

9. The method of manufacturing a display device, extending the substrate is performed by using an X-axis direction extension mechanism to extend the substrate in an X-axis direction and a Y-axis direction extension mechanism to extend the substrate in a Y-axis direction, and the substrate is extended simultaneously in the two-dimensional directions by using an extension mechanism in which the X-axis direction extension mechanism and the Y-axis mechanism are coupled to each other.

10. The method of manufacturing a display device according to claim 8, the display device being a liquid crystal display device, and the method further comprises:
injecting a liquid crystal into the element layer after forming the element layer, and
the substrate being extended after injecting the liquid crystal.

11. The method of manufacturing a display device according to claim 8, the method further comprising:
forming a sealing layer to seal the substrate before extending the substrate, the sealing layer being made of thermosetting material which is cured in response to thermal energy or light curable material which is cured in response to optical energy; and
curing step of curing the sealing layer after extending the substrate.

12. A method of manufacturing a display device in which an element layer having electrodes and a photo-functional layer is formed on a substrate, the substrate is made of a thermal-shrinking material exhibiting shrinkage in response to thermal energy, and the element layer is made of an elastic material and has an adhesive property to the substrate, the method comprising:
forming the element layer on the substrate; and
shrinking the substrate in response to thermal energy after forming the element layer.

13. A method of manufacturing a display device in which an element layer having electrodes and a photo-functional layer is formed on a substrate, the substrate being made of optical-shrinking material exhibiting shrinkage in response to optical energy, and the element layer being made of an elastic material and having an adhesive property to the substrate, the method comprising:
forming the element layer on the substrate; and
shrinking the substrate by the optical energy after forming the element layer.

14. A method of manufacturing a display device in which an element layer having electrodes and a photo-functional layer is formed on a substrate, both the substrate and the element layer are made of an elastic material, and the element layer has an adhesive property to the substrate, the method comprising:
extending the substrate before forming the element layer;
forming the element layer on the substrate after extending the substrate; and
shrinking the substrate so as to make the display device be a desired size, after forming the element layer.

15. The method of manufacturing a display device according to claim 14, the substrate made of an autogenous shrinkable elastic material,
in extending the substrate, the substrate is fixed to an extended state by using an extension mechanism to extend the substrate in an X-axis direction and/or a Y-axis direction, and
in shrinking the substrate, the extension mechanism is released.

16. The method of manufacturing a display device according to claim 14, the substrate made of an elastic material exhibiting irreversibility in response to thermal energy, and
in shrinking the substrate, the thermal energy is applied to the substrate at the same time as shrinking the substrate.

17. The method of manufacturing a display device according to claim 14, the method further comprising:
curing the substrate in response to thermal energy after shrinking the substrate.

18. The method of manufacturing a display device according to claim 14, the method further comprising:
curing the substrate in response to optical energy after shrinking the substrate.

19. The method of manufacturing a display device according to claim 12, the method further comprising:
forming step of forming a sealing layer to seal the substrate before the shrinking the substrate, the sealing layer being made of a thermosetting material which is cured in response to thermal energy, or a light curable material which is cured in response to optical energy; and
curing the sealing layer after shrinking the substrate.

20. The method of manufacturing a display device according to claim 11, the display device being an active panel and having active elements made of an elastic material, and
the method further comprising:
forming active elements on the substrate.

21. The method of manufacturing a display device according to claim 20, at least one of the electrodes, the photo-functional layer, the sealing layer, and the active elements formed using an inkjet method.
